(19) United States
(12) Patent Application Publication
(10) Pub. No.: US 2023/0366705 A1
(43) Pub. Date: Nov. 16, 2023

(54) APPARATUS AND METHOD FOR THE DETECTION OF PROPERTIES OF A PIPE

(71) Applicant: Datatecnics Corporation LTD, Edgbaston (GB)

(72) Inventors: Suhayl ZULFIQUAR, Edgbaston (GB); Ben FORREST, Edgbaston (GB)

(21) Appl. No.: 18/360,423

(22) Filed: Jul. 27, 2023

Related U.S. Application Data
(63) Continuation-in-part of application No. 17/759,444, filed on Jul. 26, 2022.

(30) Foreign Application Priority Data
Jan. 27, 2020 (GB) 2001136.7

(51) Int. Cl. G01D 11/24; G01K 1/143; G01B 5/30; G01D 21/02; G01D 11/30

(52) U.S. Cl. CPC G01D 11/245; G01K 1/143; G01B 5/30; G01D 21/02; G01D 11/30

(57) ABSTRACT

A system is provided for determining one or more properties of a pipe. The system includes an attachment pad and at least one sensor configured to be coupled to the outside of a pipe wall. The attachment pad is configured to overlie one or more of the at least one sensor such that the one or more sensor may be positioned between the pipe and the attachment pad, and also configured to prevent slippage of the one or more sensor on the pipe.

### CROSS REFERENCE TO RELATED APPLICATIONS

This application is a continuation-in-part application of and claims the benefit of priority to U.S. patent application Ser. No. 17/759,444, filed on Jul. 26, 2022, which is a National Phase of PCT/GB2021/050189, filed on Jan. 27, 2021, which claims priority to British Patent Application No. 2001136.7, filed on Jan. 27, 2020, the disclosures of each of which are hereby incorporated by reference in their entireties.

### FIELD OF INVENTION

The invention is in the field of the measurement of properties of pipes to determine their health condition. Pipes are often in subterranean environments, and the invention may be particularly advantageous in such environments.

### BACKGROUND

Pipelines are highly useful fluid transportation systems. For example oil pipes may be used to transport oil around the world. Gas is similarly transported in pipes. Moreover, water is another fluid that is transported with pipes. Water pipes are particularly interesting as the value of the fluid is relatively low, but is essential to agriculture and for drinking supply for local populations. Due to the relatively low monetary value of water, water pipes are often less well maintained as there are fewer resources spent on such pipes. These pipes are often aged, and often have large amount of leaks, which results in a large amount of lost water. Monitoring such pipes in a cost effective way is therefore advantageous. Pipes are also very difficult to monitor given their length and the sought-after nature of the commodities within them.

Fibre optic cables have been used to monitor the properties of pipes, however such systems are costly and difficult to implement. Therefore there is a need for an alternative system that is more cost effective to implement.

Present strain gauges are also known as apparatus to monitor the strain of various surfaces. However, at present many strain gauges are notorious for being liable to breakage. They are often difficult to attach to the surface being measured. Moreover, in environments where they cannot readily be replaced, and where they may be subject to high pressures, and large fluctuations in temperature, present strain gauges are not well suited. A new sensor that may be in the form of a strain gauge is desired that addresses at least one, or alternatively all, of the shortcomings listed above.

Pipes such as water pipes are prone to damage as a result of a number of external factors. For instance, water pipes are often located in subterranean environments which can either be in urban or rural settings.

In urban settings heavy flows of traffic can cause movement of earth surrounding the pipes, and such forces provided by traffic may commonly be at a set frequency (e.g. based on the time between vehicles on a road).

Some pipes may incorporate pumps for example to pump effluent or other fluids up an incline. Such pumping action may induce an acceleration to the pipe at a regular frequency.

In rural settings wear on the pipes may be largely due to freeze-thaw (in winter) or due to the effect of a lack of damping from hardened surrounding earth (in the summer months).

At present pipes are not live-monitored. Instead, water companies simply assign each pipe a lifespan and then seek to replace each pipe as they come up to the end of their lifespan. Therefore there are breakages where pipes fail before they are replaced. This causes complex works, often involving shutting down public roads.

### SUMMARY OF INVENTION

The present application relates to sensors for live monitoring of such pipes so that the health of the pipe may be assessed. This may lead to an early replacement of specific section of pipe. Alternatively, it may mean that when certain parameters are sensed (e.g. hardened surrounding soil) usage of the pipe may be minimised or curtailed.

Such live monitoring is technically challenging as it is difficult to ensure the veracity of data obtained in a subterranean environment, as noise can dominate signals. Moreover it is important that a system is simple and quick to fit such that adding the monitoring to the pipes does not in itself cause large delays in work to public roads and the like.

According to a first exemplary aspect, there is an attachment pad configured to prevent the ingress of moisture into the vicinity of a sensor attached to a pipe, the attachment pad configured to overlie one or more sensors such that the one or more sensors may be positioned between the pipe and the attachment pad. This is advantageous as it may protect a sensor from the environment in which the pipe is located. For example in a subterranean environment the attachment pad may provide mechanical protection to the sensor from soil, sharp debris, stones and anything else that might contaminate or physically damage that sensor.

Optionally, the attachment pad having a first face, a second face, and wherein the first face comprises an indent configured to house at least one sensor when the at least one sensor is coupled to the pipe. The indent may further reduce the pressure applied to the sensor during use.

Optionally, the second face of the attachment pad having a raised portion, aligned with the indent. This allows the thickness of the attachment pad to be substantially uniform to allow the pressure to de dissipated evenly.

Optionally, the attachment pad has a thickness of 1 mm, preferably the thickness being in the range of 1 mm to 10 mm, preferably 6 mm. This thickness may provide additional protection to the sensor. This range of thicknesses may enable ease of installation of the attachment pad. This thickness may also make process of adhering the attachment pad less time consuming.

Optionally, the attachment pad is formed of a resilient material, such that the attachment pad is more resilient than the sensor. This is advantageous as the attachment pad may protect the sensor through its resilience.

Optionally, one or more attachment pads are sufficient to span the entire perimeter of the pipe. Advantageously this ensures that the section of the pipe is entirely covered so that the forces on the pipe are uniform in all directions.

Optionally, the one or more attachment pads span the pipe once but only once.

Advantageously this keeps the thickness of the attachment pads on the pipe constant so that forces on the pipe are equal across the entire perimeter of the pipe.

Optionally, the attachment pad is tessellatable with itself such that two or more attachment pads may span the entire perimeter of the pipe. This enables a single size pad to be used for various pipes of differing circumference.

Optionally, the attachment pad is configured to be adhered to the pipe by adhesive, and/or wherein the attachment pad is curable/weldable to adhere to the pipe. Electrofusion welding for example may be used. This enables the attachment pad to be adhered to the pipe in an easy and reproducible manner.

Optionally, the attachment has a sufficient level of friction with the pipe such that adherence between the pipe and the attachment pad is caused. This is advantageous as it allows the pad to be adhered without the need for adhesive, making the installation simpler.

Optionally, wherein the attachment pad is configured to house an analogue to digital converter configured to convert an analogue signal measured by the sensor into a digital signal.

According to a second aspect there is a sensor for measuring a parameter of a pipe, the sensor comprising a flexible plastic, or metallised plastic, base layer, an ink trace forming an electronic circuit for measuring at least one parameter, preferably a protective layer encasing the ink trace, wherein the sensor has a poisons ratio of 0.35 to 0.45 such that the sensor is configured to elastically deform under dynamic short term loading, as well as through gradual changes to loading through for example the compaction of soil. This is advantageous as it allows ease of installation of the sensor, as it may be handled without a large amount of care, and it may be attached easily to many surfaces. The flexibility may also be particularly good at withstanding the pressure of subterranean environments. Poisson values in the range 0.37 to 0.44 May be particularly advantageous, and a value of 0.44 is even more advantageous.

Optionally, the sensor is configured to measure at least one property of the pipe. This allows features of the pipe to be analysed to check the health of the pipe, and the likelihood of failure.

Optionally, the sensor is configured to measure at least one of strain, temperature, humidity, pressure and acceleration. Strain may allow the likelihood of a fracture to be identified. Temperature may also measure the likelihood of damage from the elements, for example from freeze/thaw. Acceleration may give an indication of any movement of the pipe, or if there is a blockage inside the pipe. Humidity may help understand variability of soil condition leading to irregular loading. Pressure may allow an understanding of the level of load being applied and how this changes over time.

Optionally, at least four sensors are coupled to the pipe, such that the two sensors closest the top of the pipe are equidistant to the top of the pipe. This may enable to a particularly effective form of measurement.

Optionally, the sensor is configured to measure strain in two axis that are perpendicular to one another. This advantageously allows both axial and circumferential strain to be measured. An optional alternative may to measure the strain in an axis, and to measure the strain at another axis at forty five degrees to the first axis, such that the two axis are diagonal from one another.

Optionally, the sensor comprises two measurement modules positioned perpendicular to one another. This advantageously enables simple measurement of both the axial and circumferential strain.

According to a third aspect there is a system for determining one or more properties of a pipe, the system comprising an attachment pad, at least one sensor configured to be coupled to the outside of a pipe wall, wherein the attachment pad is configured to overlie one or more of the at least one sensor such that the one or more sensor may be positioned between the pipe and the attachment pad, and to prevent slippage of the one or more sensors on the pipe. The system may be particularly effective at measuring the properties of a pipe in a cost effective way to enable the health condition of a pipe to be determined. The sensor is also sufficiently protected such that it is less likely to fail, and so reducing the frequency at which the sensor may be needed to be replaced.

Optionally, at least three sensors are coupled to the pipe, and further wherein the top of the pipe nearest the ground is free from a sensor, such that it may be accessed for maintenance, and wherein the sensors are equidistant from each other around the circumference of the pipe. This is advantageous as engineers often have to tap into the top of the pipe in order to enter the pipe to perform maintenance.

Optionally the system further comprising a data acquisition module configured to be in communication with at least one sensor to receive data, the data acquisition module configured to process the data to determine one or more properties of the pipe. This advantageously enables the data from the sensors to be analysed.

Optionally, the system further comprises a plurality of sensors connected to the data acquisition module, wherein the sensors are connected to the data acquisition module by at least one of: direct connections between the plurality of sensors and the data acquisition module, wherein the direct connections are in parallel with one another, direct connections between the plurality of sensors and the data acquisition module, wherein the direct connections are in series with one another, connections between the plurality of sensors and the data acquisition module, wherein said connections are via a connecting element, and wherein the connections between the plurality of sensors and the connecting element are in parallel with each other; or connections between the plurality of sensors and the data acquisition module, wherein said connections are via a connecting element, and wherein the connections between the plurality of sensors and the connecting element are in series with each other.

Optionally, the system further comprises a junction box configured to be connected to the at least one sensor, such that data measured by the sensor can be communicated to the junction box. Advantageously the junction box allows all of the sensors to connect to a single point, such that the connections are less likely to be caught by a subterranean environment.

Optionally, the data acquisition module is configured to be in direct communication with the junction box. Advantageously this enables all of the data to reach the data acquisition module in a single connection.

Optionally, in use, the junction box is positioned at least far enough away from the sensor so that the junction box does not cause stress or strain on the pipe, and is positioned close enough to the sensor such that noise is not introduced into the signal. This is highly advantageous as it reduces the chance of the measurement system damaging the pipe itself, whilst ensuring the accuracy of the data collected.

Optionally, in use, the junction box is positioned between 0.5 m and 1.5 m away from the sensor. These values may be particularly advantageous for protecting the pipe, and ensuring accurate data protection.

Optionally, the data acquisition module is housed within a meter chamber. This may protect the data acquisition module from the subterranean environment.

Optionally, the meter chamber is machined to make cable accessibility straightforward, and is configured to be weatherproof, such that the data acquisition module is not affected by groundwater. Advantageously this protects the data acquisition module.

Optionally, the meter chamber further comprises a power subsystem to power the data acquisition module. This enables the data acquisition module to be powered locally.

Optionally, the system further comprises a pressure sensor configured to be tapped into the pipe in the vicinity of at least one sensor, to determine the pressure of fluid in the pipe. The pressure in the vicinity of the sensors may be advantageous as it may provide an understanding of hydraulic activity and its subsequent effect on the pipe.

According to a fourth aspect there is a method of installing at least one sensor on a pipe, comprising attaching the one or more of the at least one sensors of the second aspect to the pipe, and overlaying at least one of the one or more sensors, with the attachment pad of the first aspect. This advantageously enables a quick and easy installation method.

Optionally, the method further comprises curing the one or more sensors such that the at least one sensor couples to the pipe wall. Advantageously this increases the bond between the sensor and the pipe.

Optionally, the curing comprises applying a pressure for a set period of time, and/or wherein curing comprises applying heat for a set period of time. Advantageously, this enables the bond between the sensor and the pipe to be strong.

Optionally, the method further comprises curing the one or more attachment pads to permanently couple the attachment pads to the pipe wall. This is advantageous as it allows the attachment pads to have a secure bond to the pipe wall.

Optionally, curing comprises applying a pressure for a set period of time, and/or wherein curing comprises applying heat for a set period of time. This is advantageous for the reasons set out above.

Optionally, the method further comprises connecting the one or more sensors to a data acquisition module. This enables the data to be analysed effectively so that any faults in the pipe may be found.

Optionally, connecting the one or more sensors to a data acquisition module comprises connecting the one or more sensors to a junction box, and then connecting the junction box to a meter chamber containing a data acquisition module. This enables the connections to be secure, and to ensure the cables are at less risk of damage.

Optionally, attaching the one or more sensors to the pipe comprises positioning the at least one sensor correctly in both the longitudinal and circumferential axis. This ensures that the calculations to determine axial strain and circumferential strain are simpler and so require less processing power.

Optionally, attaching the one or more sensors to the pipe comprises attaching the one or more sensors to the outer surface of the pipe with an adhesive or epoxy, or by curing/welding, for example electrofusion welding. This may advantageously allow a quick and easy bond to be formed.

A fifth aspect comprises a pipe for transporting fluids, the pipe extending from a distal point, to a proximal point, wherein the pipe is configured for fluid to flow through the pipe from the distal point to the proximal point, wherein the pipe comprises a pipe wall comprising an inside surface, and an outside surface, and wherein a lumen is encapsulated by the inside surface of the pipe wall such that fluid may flow through the lumen, and further wherein the pipe is coupled to the sensor of the second aspect, and to the attachment pad of the first, such that the sensor may be positioned between the pipe and the attachment pad. Advantageously this secures a sensor to a pipe such that it may monitor various aspects of the pipe to determine faults.

In accordance with a sixth aspect of invention there is provided a sensor for measuring parameters of a pipe, the sensor comprising a sensor body comprising a pipe engaging surface; a first measurement device positioned within the sensor body and configured to contact the surface of the pipe when the pipe engaging surface is in contact with the surface of the pipe, wherein the first measurement device is configured to measure a first parameter of the pipe; a data conduit configured to pass the measurement from the measurement device to an external unit. This may advantageously allow for the sensor to be surrounded by a sensor body. This may reduce the risk of damage to the measurement device, e.g. from the subterranean environment or water ingress.

Optionally, the first measurement device is configured to output an analogue measurement, and wherein said analogue measurement is converted to a digital signal in the vicinity of the pipe. This may be particularly advantageous. Sensors located in subterranean environments may output analogue signals and these may be susceptible to noise during transit to the surface (e.g. to an external unit on the surface). Therefore analogue to digital conversion in the subterranean environment in the vicinity of the pipe may address this problem. This may either be through an analogue to digital converter situated within the sensor itself, or an analogue to digital converter situated in a junction box that is configured to be adjacent the sensor and the pipe. The junction box may be connected to multiple sensors so as to provide efficient signal conversion.

Optionally, the sensor body is comprised of a casted material. This may advantageously minimise any water ingress to the measurement device.

Optionally, the sensor body is formed from a polymeric material, such as silicone or polyurethane. These may be materials that do not allow the infiltration of water or other materials form the subterranean environment.

Optionally, the sensor body is formed from polyurethane or silicone that is set around the first measurement device and the data conduit. This may offer the maximum protection of the measurement device. It may also allow the connection between the measurement device and the pipe to be flush and less susceptible to fluid ingress.

Optionally, the first measurement device is configured to lie flush with the pipe engaging surface of the sensor body. This may allow the connection between the sensor and the pipe to be as strong as possible, and to minimise the chance of an external shock changing the position the sensor relative to the pipe.

Optionally, the system further comprises a second measurement device configured to contact the surface of the pipe when the pipe engaging surface is in contact with the surface of the pipe, wherein the second measurement device is configured to measure a second parameter of the pipe. This may allow two parameters to be measured in proximity to one another such that the interrelation between these parameters can be used to determine the health of the pipe.

Optionally, the second measurement device is configured to lie flush with the pipe engaging surface of the sensor body. This may allow the connection between the sensor and the pipe to be as strong as possible, and to minimise the chance of an external shock changing the position the sensor relative to the pipe.

Optionally, the first measurement device is configured to measure strain. This may allow the displacement of the pipe relative to a reference length to be determined. This measure may be linked to potential breakage events if the strain becomes too large and plastic deformation ensues.

Optionally, the second measurement device is configured to measure temperature. Temperature and strain may be linked, and so this may allow changes in strain in the pipe to be understood, and where those changes are not as a result of temperature to be identified as strain events.

Optionally, the controller is configured to modify the strain measurements to take into account temperature fluctuations that have been detected. This may allow the health of the pipe to be assessed.

Optionally, the system further comprises an accelerometer configured to detect any acceleration or motion of the sensor. This may detect events that cause breakages or damage to the pipe.

Optionally, a notification is created if an acceleration over a first threshold is detected, wherein the first threshold is indicative of an external subterranean stimulus such as seismic activity, and/or wherein the threshold is indicative of accelerations that are repeating at a frequency associated with damage of infrastructure. This may be advantageous for detection of local subterranean shocks—e.g. due to a vehicle with a heavy load, or a travelling at a high speed, or larger scale events such as earthquakes. Additionally where the threshold relates to a frequency at which an acceleration is applied this may allow any potential resonance events to be identified. For example, pumps or traffic that operate at a system may be identified, and if the system is additionally identified as becoming undamped (e.g. because of a lack of moisture in the surrounding soil) then this may result in an alarm condition.

Optionally, the system further comprises an additional sensor such as a load cell or a moisture detection unit. These sensors may provide additional information to aid the monitoring of the pipe network.

Optionally, the load cell is encapsulated within the sensor body, and wherein the load cell is configured to be positioned at the top of the pipe. The encapsulation of the load cell may reduce the possibility of it being damaged by an external event. Whilst the position of the load cell may allow it to accurately determine the vertical load on the pipe, as this can be linked to breakage events or damage.

Optionally, the moisture detection unit is configured to indicate when the moisture level drops below a pre-set threshold, wherein said threshold indicates that the soil no longer provides sufficient damping and so damage is more likely. This may be advantageous for determining when the pipe is in an undamped state and therefore susceptible to damage, e.g. from resonance events.

Optionally, the pipe is positioned underground, and wherein the sensor is configured to be positioned on the pipe underground. This may allow for direct local measurements of the pipe in situ and during use.

Optionally, the external unit is situated above the ground. This may allow data from the measurement device to be sent to a usable location.

Optionally, the data is passed to the external unit via a junction box. In some instances this may allow the junction box to gather multiple sources of data, e.g. from multiple sensors. This may allow for efficient transmission to the external device.

Optionally, the sensor body is cylindrically shaped, wherein the diameter of the cross sectional area is larger than the depth of the cylinder, such that the sensor body is approximately disc or puck shaped. This may allow the sensor to be simple to manufacture, and advantageously simple and time efficient to fit to a pipe. This may be particularly advantageous for embodiments in which no controller is present in the sensor, as this may allow for simple manufacture (and in such embodiments other shapes may also be used).

Optionally, the sensor further comprises a controller encapsulated within the sensor body, wherein the controller is configured to convert measurements from the first measurement device into a digital signal. This may allow the measurement form the measurement device to be converted to a digital signal entirely locally so that no transmission of an analogue signal is required. This would therefore minimise any noise being induced into the signal.

Optionally, the data conduit is configured to pass the digital signal of the measurement to the external device. A digital signal is less susceptible to noise, and so this is advantageous.

Optionally, the data conduit is a data transmitter, and is configured to send the measurement from the measurement device to an external unit.

Optionally, the pipe engaging surface further comprises a first flange extending from a central portion. The flanges may allow for a particularly effective bond between the pipe and the sensor to be created.

Optionally, the central portion extends longitudinally in a first direction and is dimensioned such that the longest side of the central portion extends in the first direction.

Optionally, the first flange extends further in the first direction.

Optionally, the pipe engaging surface comprises two side flanges extending from the central portion. The flanges may allow for a particularly effective bond between the pipe and the sensor to be created.

Optionally, the first direction is perpendicular to the two side flanges. The flanges may allow for a particularly effective bond between the pipe and the sensor to be created.

Optionally, the first measurement device is housed in the first flange. This may allow the parameters of the pipe to be measured effectively.

Optionally, the second measurement device is housed in the first flange. This may allow the parameters of the pipe to be measured effectively. This may also allow the two parameters to be measured on the same local portion of pipe.

Optionally, the controller is housed in the central portion. This may best protect the controller form external forces.

Optionally, the accelerometer is housed in the central portion. This may provide a more accurate acceleration reading, as it would not be based on relative movement of the flanges relative to the central portion.

Optionally, the load cell is housed in the central portion. This may provide the most accurate measurement of load on the pipe.

Optionally, the data conduit comprises a wired connection. This may further reduce noise in the signal that is sent. In particular, if the wired connection is directly to a junction box, and even more particularly where the analogue to digital conversion is performed after the signal is sent to the junction box.

Optionally, the wired connection is positioned to extend away from the central portion in the opposite direction to the first flange. This may make the sensor simple to install on the pipe.

In accordance with a seventh exemplary aspect, a system is provided that comprises a junction box; at least one sensor in accordance with the first aspect; wherein the sensors are each attached to the junction box via the data conduit. This may allow for efficient management of the data from the measurement devices in the one or more sensors.

Optionally, the system further comprises an analogue to digital converter for converting the measurement from the measurement device to a digital signal. This may be advantageous, especially if the converter is present in the junction box and multiple sensors are attached to the junction box. This may reduce the amount of power required for the system as only one processor is used. As the system is in a subterranean environment, and as the system is for ease of deployment it may be powered by a battery. And therefore reducing the power consumption of the system may prolong the life of the system.

Optionally, the at least one sensor is a plurality of sensors, and optionally wherein the plurality of sensors comprises four sensors. This may provide sufficient data to characterise the health of the pipe.

Optionally, the attachment between the junction box and the data conduit is configured to be water resistant. This may reduce noise on the signal, and increase the lifespan of the system.

Optionally, wherein the data conduits of the sensor is encapsulated within the junction box. This may mean that the sensors and the junction box and the data conduit form a single piece to be fitted to the pipe. This may reduce the time associated with installation. This may also reduce any chance of water ingress.

Optionally, the data conduit of the sensor is attached to the junction box via a stuffing gland. For embodiments in which the junction box is not encapsulated a stuffing gland may allow an encapsulated sensor/data conduit to be attached to an non-encapsulated junction box in a water resistant manner.

Optionally, the attachment is via two stuffing glands forming a male to female connection. This may allow for ease of attachment, and a water resistant connection.

Wherein at least one sensor comprises a load cell encapsulated in the sensor body, optionally wherein said sensor is configured to be positioned atop the pipe. This may allow the load on the pipe to be determined and monitored live during use of the pipe.

Optionally, the system further comprises a moisture gauge, configured to detect the moisture level of the surrounding earth or soil. This may advantageously allow any dry conditions resulting in an undamped pipe to be identified.

Optionally, the moisture gauge comprises a first and second prong and comprises a capacitive moisture sensor.

Optionally, the moisture gauge is connected to the junction box. This may provide a single point at which each sensor is connected.

Optionally, the moisture gauge is configured to output an analogue measurement, and wherein the analogue measurement is configured to be converted to a digital signal.

Optionally, the conversion is configured to take place in the subterranean environment. This may reduce any noise in the signal. In embodiments where this conversion takes place in the junction box power may also be saved.

In accordance with an eighth exemplary aspect, a method is provided of taking a subterranean measurement of a pipe situated beneath the ground, the method comprising measuring a first parameter of the pipe using a first measurement device; converting the measurement from the first measurement device into a digital signal, wherein said conversion takes place locally under the ground and adjacent the pipe; sending the digital signal to an external unit situated above the ground.

This may reduce the noise in the signal received above ground.

In accordance with a ninth exemplary, a method is provided of taking a subterranean measurement of a pipe situated beneath the ground, the method comprising measuring a first parameter of the pipe using a first measurement device; passing the analogue signal to a junction box situated below the ground, wherein the external unit comprises a controller; converting, at the controller, the measurement from the first measurement device into a digital signal; and sending the digital signal to a secondary external unit situated above the ground. This may provide an alternative embodiment in which noise is reduced, and power used by the system is also reduced.

In accordance with a tenth exemplary aspect, a method is provided of attaching the sensor that comprises covering either the pipe or the pipe contacting surface of the sensor body with adhesive; pressing the first flange of the sensor to the pipe; pressing the central portion of the sensor to the pipe; and pressing the side flanges of the sensor to the pipe such that the measurement device is in contact with the pipe. This may provide a secure connection between the pipe and the sensor.

In accordance with an eleventh exemplary aspect, a method of manufacturing the sensor is provided that includes positioning the first measurement device and the data conduit in a mould; pouring a fluid into the mould such that the fluid fills the mould; curing the fluid; and removing the sensor from the mould. This may provide a simple, cost effective method of manufacture to reduce cost of the sensors.

Optionally, positioning the first measurement device and the data conduit in the mould further comprises positioning the controller in the mould. This may reduce steps of manufacture.

### BRIEF DESCRIPTION OF THE DRAWINGS

FIG. 1 shows a plan view of the attachment pad from above.

FIG. 2 shows a cross-sectional view of the attachment pad through the indent region.

FIG. 3 shows a sensor with three measurement modules in a triangular arrangement.

FIG. 4 shows a sensor of a first embodiment with two measurement modules in a circular arrangement.

FIG. 5 shows a sensor with four measurement modules in a cross-shaped arrangement.

FIG. 6 is a plan view of the base layer of the sensor, demonstrating the flexibility of the base layer of the sensor.

FIG. 7 is a cross-sectional view of the base layer of the sensor when the base layer of the sensor is compressed to demonstrate its flexibility.

FIG. 8 shows an attachment pad and a sensor in situ on a pipe.

FIG. 9 shows four attachment pads that together span the perimeter of the pipe.

FIG. 10 shows three attachment pads that together span the perimeter of the pipe.

FIG. 11 shows four sensors attached to the pipe in one sensor arrangement. The attachment pads are not shown.

FIG. 12 shows three sensors attached to the pipe in one sensor arrangement. The attachment pads are not shown.

FIG. 13 shows the steps of installation for the sensors on the pipe.

FIG. 14 shows the system of the sensors attached to the pipe, with the junction box and meter chamber in use. FIG. 14 is a cross-sectional view along the length of the pipe.

FIG. 15 shows an embodiment of the system in which no junction box is present and the plurality of sensors are arranged in series with one another, and connected directly to the data acquisition module.

FIG. 16 shows an embodiment of the system in which no junction box is present and the plurality of sensors are arranged in parallel with one another and are connected to the data acquisition module via a connector.

FIG. 17 shows an embodiment of the system in which no junction box is present and the plurality of sensors are arranged in parallel with one another, and are connected directly to the data acquisition module.

FIG. 18 shows an embodiment of the system in which the junction box is present and the plurality of sensors are arranged in parallel with one another.

FIG. 19 shows an embodiment in which an analogue to digital converter is positioned adjacent the attachment pad and the sensor.

FIG. 20 shows a sensor in accordance with a second embodiment in a perspective view

FIG. 21 shows a cross sectional side view of the sensor of FIG. 20.

FIG. 22 shows a plan view of the sensor of FIG. 20 from below.

FIG. 23 shows a plan view of the sensor of FIG. 20 from above.

FIG. 24 shows a sensor in accordance with a third embodiment in a perspective view.

FIG. 25 shows a cross sectional side view of the sensor of FIG. 24.

FIG. 26 shows a plan view of the sensor of FIG. 24 from below.

FIG. 27 shows a plan view of the sensor of FIG. 24 from above.

FIG. 28 shows a cross sectional view through a pipe to which a plurality of sensors of the second embodiment of FIG. 20 are attached, and wherein the sensors connect to a junction box.

FIG. 29 shows a cross sectional view through a pipe to which a plurality of sensors of the third embodiment of FIG. 24 are attached, and wherein the sensors connect to a junction box.

FIG. 30 shows a cross sectional view through a pipe to which a plurality of sensors of the second embodiment of FIG. 20 are attached, and wherein the sensors connect to a junction box via a stuffing gland.

FIG. 31 shows a cross sectional view through a pipe to which a plurality of sensors of the third embodiment of FIG. 24 are attached, and wherein the sensors connect to a junction box via a stuffing gland.

FIG. 32 shows a flowchart outlining a method of using a sensor of the second embodiment to take a subterranean measurement of a pipe situated beneath the ground.

FIG. 33 shows a flowchart outlining a method of using the sensor of the third embodiment take a subterranean measurement of a pipe situated beneath the ground.

FIG. 34 shows a flowchart outlining a method of attaching a sensor to a pipe.

FIG. 35 shows a flowchart outlining a method of manufacturing a sensor.

### DETAILED DESCRIPTION

The Figures are described below, and each Figure is merely an illustration of an embodiment. The features shown in the Figures are not considered essential unless otherwise stated.

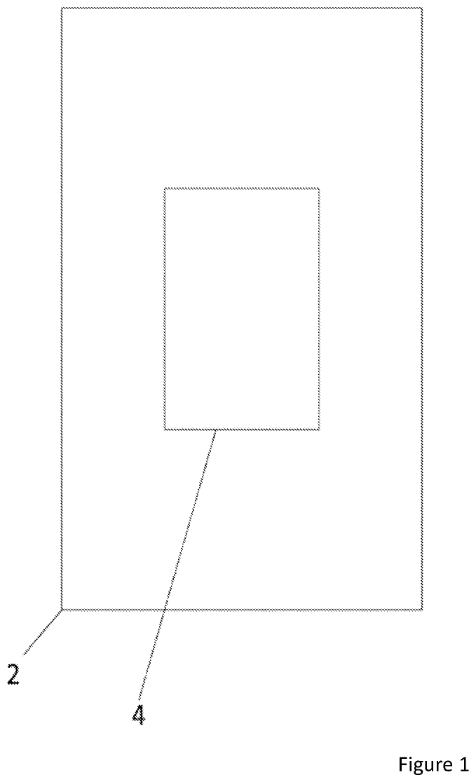

FIG. 1 shows an attachment pad 2. The attachment pad 2 is viewed from an orientation that is applied face down to the pipe, such that the length and width of the attachment pad 2 are shown, but the depth of the attachment pad 2 is not. FIG. 1 shows an indent 4 protruding into the face of the attachment pad 2 exposed to the subterranean environment.

The attachment pad 2 is configured to prevent the ingress of moisture and dirt into the vicinity of a sensor attached to a pipe, and to overlie one or more sensors such that the one or more sensors may be positioned between the pipe and the attachment pad 2.

The indent 4 shown in FIG. 1 is configured to overlie the one or more sensors. The indent 4 in FIG. 1 is shown as being in a substantially central position within the attachment pad 2. This may allow for strain to be evenly distributed. However, the indent may be positioned off-centre for other reasons, such as positioning of the sensor on the pipe.

The attachment pad 2 may be formed of a resilient material, such that the attachment pad 2 is more resilient than the sensor. This may enable the attachment pad 2 to withstand higher forces, pressures, or temperatures than the sensor could withstand on its own. The attachment pad 2 may therefore protect the sensors housed therein from such forces though its resilience.

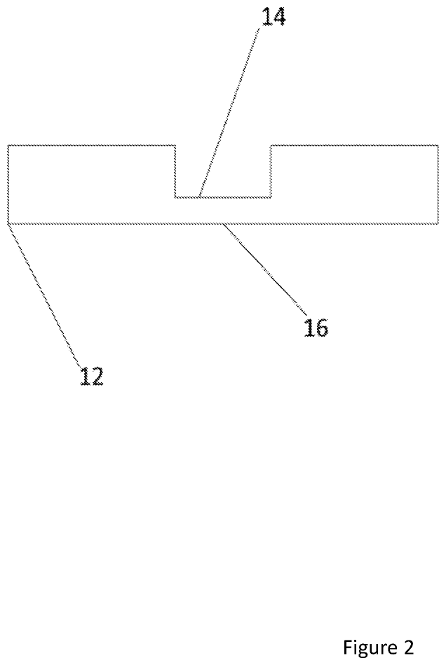

FIG. 2 shows a cross-section of the attachment pad 12. The depth and length of the attachment pad 12 are visible, but not its width. The indent 14 shown in FIG. 1 is visible in FIG. 2. In FIG. 2 the side opposite the indent is flush 16. However in other embodiments a raised portion may also be present. The raised portion may be aligned with the indent 14. FIG. 2 shows that in some embodiments the thickness of the attachment pad 12 is constant throughout the length of the attachment pad 12. The attachment pad may have a thickness of at least 1 mm, and more preferably a thickness of between 1 mm and 10 mm, or 1 to 6 mm.

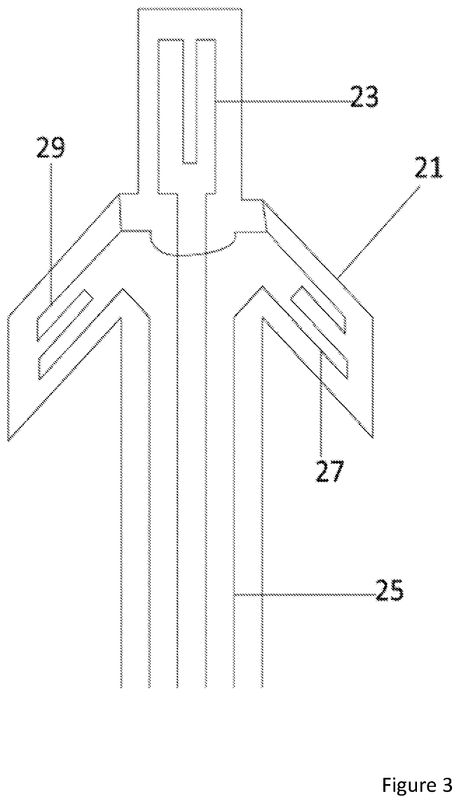

FIG. 3 shows one embodiment of the circuitry 25 provided within the sensor 21. FIG. 3 shows an embodiment with three sensor elements 21, 27, 29 shown. Each sensor element may be a strain gauge to monitor the shear stress at a 45 degree angle. FIG. 3 shows a triangular-like distribution of the sensor elements around the sensor 21. Four channels are present, three are which are associated with each of the sensor elements. The sensor 21 may be formed by printing the circuitry 25 directly on to the base layer. For example conductive ink may be used to form the circuitry 25.

The three sensor elements may allow both the axial and circumferential strain to be measured. For example, the central sensor 23 element may be positioned so as to measure axial strain. Both of the outer sensor elements 27, 29 may be used to measure the circumferential strain. For example the outer elements 27, 29 may be positioned to directly measure circumferential strain alone, or as shown, the elements may be positioned to measure a mixture of both circumferential and axial strain. Using the measurements form the central sensor element the circumferential strain alone may then be measured. There may also be benefits to measuring off the axis of the circumferential strain, in a diagonal direction, as this may detect any strain events associated with helically applied loads.

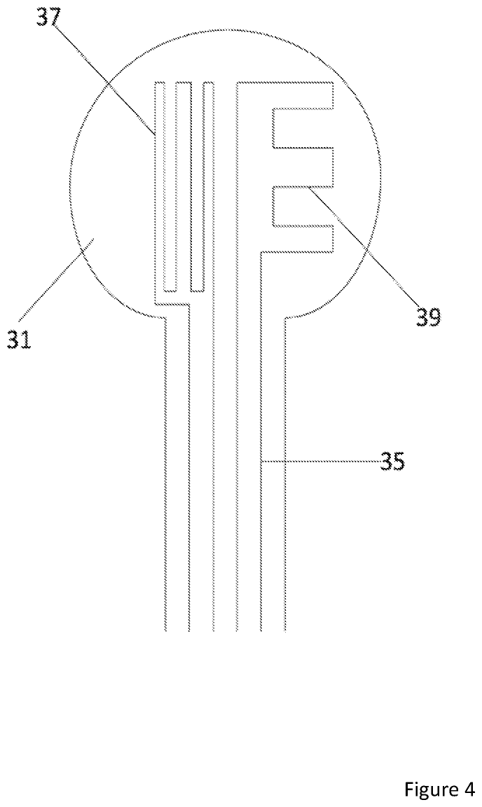

FIG. 4 shows an alternative embodiment with just two sensor elements 37, 39. There are three channels, two of which are associated with each of the sensor elements. The two sensor elements 37, 39 are arranged perpendicular to each other. The left sensor element 37 may be positioned to measure axial strain, and the right sensor element 39 may be configured to measure circumferential strain. These can be measured directly without the need for further calculation, thus reducing error. The third channel around the perimeter may be arranged into a circular shape, as shown in FIG. 4, or into any other shape.

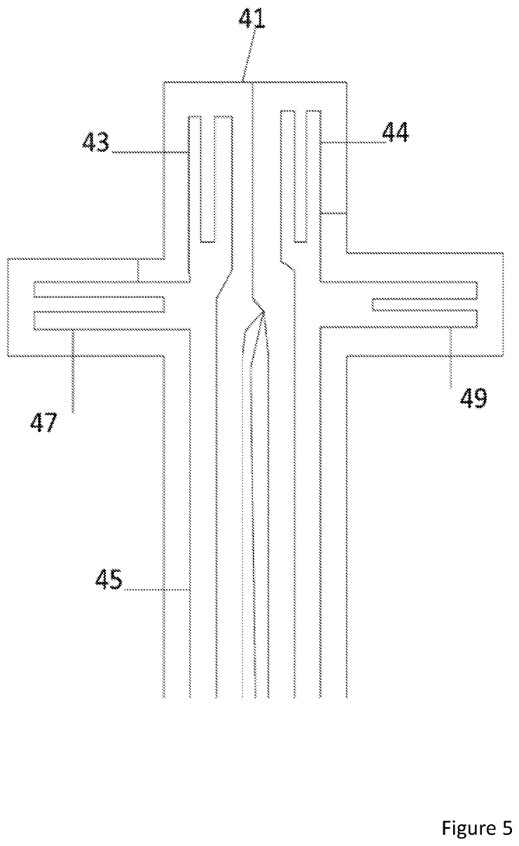

FIG. 5 shows yet another alternative embodiment, said embodiment having four sensor elements 43, 44, 47, 49. There are five channels, four of which are associated with each of the four sensor elements. Two of the sensor elements 43, 44 may be positioned so as to directly measure axial strain, whilst the other two sensor elements may be positioned so as to measure circumferential strain 47, 49. FIG. 5 may be particularly advantageous because not only are these values directly measured, but there are two measurements for each value, which further reduces the error associated with each measurement. The cross-like shape of the sensor 41 in this configuration may also be advantageous as it may be particularly easy to position on a pipe, and adhere to a pipe such that installation is easy.

It is noted that any of the embodiments shown in FIGS. 3 to 5 may also include a temperature sensing element, or a pressure sensing element. The measurement of such values may be advantageous, as data on such parameters in combination with the strain data may give indications as to the health condition of the pipe. As an additional alternative the sensing elements may be configured to detect acceleration, either of the pipe, or of fluid within the pipe in order to determine the health condition of the pipe. Strain gauges installed at multiple locations on a pipeline can be used to infer general pipeline health, however it may be advantageous to augment the use of strain gauge measurements with other measurements. For example ultrasonic sensors, load cells (to understand the load of the ground on the pipe) and vibro-acoustic sensors may be used. The combination of these sensors with strain gauges may determine a more accurate assessment of the health of the pipeline along its length than the use of strain gauges alone.

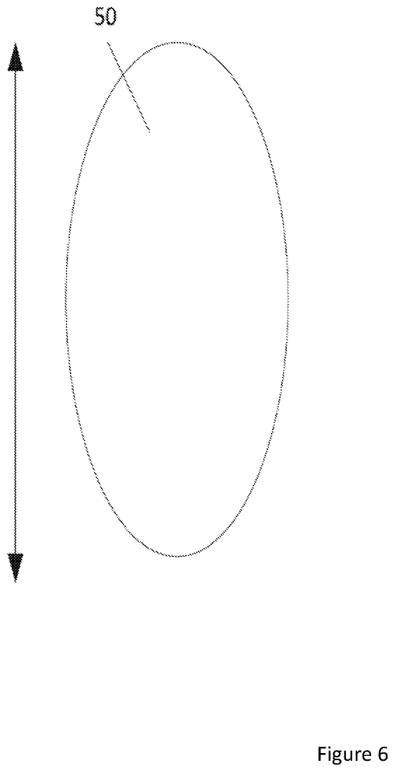

FIG. 6 shows the base layer/substrate 50 of the sensor onto which the circuitry may be printed. The substrate 50 may be any shape, and an oval is shown for simplicity alone. Also shown is an arrow indicating that the substrate is being stretched, or flexed. That is one or more forces are deforming the sensor substrate 50. The sensor however is only deforming elastically, rather than plastically, and so will return to its original shape.

The substrate 50 shown in FIG. 6 has a poisson's ratio of 0.37-0.44 such that the sensor is configured to elastically deform under dynamic and static loading over a period of time. This means that the sensor will behave elastically for these time periods under these forces. This compares with traditionally strain gauges that will deform plastically at much lower forces, or for lower periods of time. This allows ease of installation to be increased as the person installing the sensor does not have to be careful not to deform the sensor, and allows installation requiring brief deformation to take place without fear of damaging the sensor.

The use of conformable substrates also allows the circuitry to be printed directly onto the substrate 50, such that the sensor elements do not have to be formed from traditionally metal wires. Such wires are liable to breakage, and can make attaching the sensor to external circuitry particularly fiddly, and difficult to use. The printed circuitry enables the connection to be made easily, and the deformable nature of the substrate aids with installation. Moreover, during use earth around the pipe may slip slightly, and therefore compress, or distort the sensor. Traditional sensors would be hampered in such an environment and would likely fail. However, the use of the conformable substrate means that the present sensor may withstand such deformation, and so enable the use of the claimed sensors in subterranean environments.

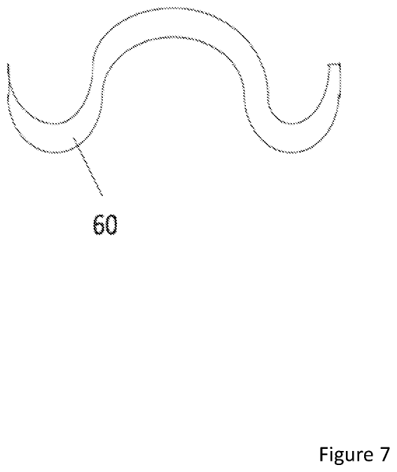

FIG. 7 is a cross-sectional view of the substrate 60 of the sensor whilst a compressive force is applied to both sides of the substrate of the sensor. This shows that the sensor deforms by bending to create wave-like folds. For such folds may be sinusoidal in shape, or may comprise other such folds. Due to the nature of the sensor substrate 60 the flexibility ensures that the sensor does not break when exposed to such forces and compressions.

It is also noted that the sensor may further comprise a protective layer to encase the ink trace. The protective layer is similarly deformable, such that both the protective layer, and the flexible plastic, or metallised plastic base layer are flexible as described above.

The sensor substrate 60, or base layer, may be formed from polyethylene terephthalate, polyaryletherketone or polyimide.

An alternative to the sensor described above may comprise foil strain gauges such as those provided by HBM and Omega. The performance of these strain gauges are known from manufacturers datasheets, and therefore the signals sent by the strain gauges can be readily understood. These devices may also be well encapsulated so that they can withstand moist and high pressure environments.

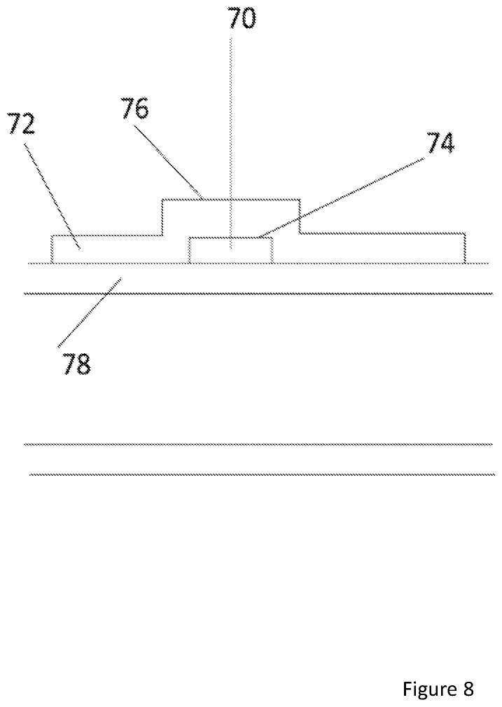

FIG. 8 shows a single sensor 70 applied to a pipe 78, and protected by a single attachment pad 72, also adhered to the pipe 78. This arrangement is shown in cross section, along the length of the pipe 78. The arrangement shown in FIG. 8 is the alternative to that shown in FIG. 2, such that the side opposite the indent 74 is not flush, and instead features a raised portion 76. Sensors 70 may be installed at multiple sections of pipe 78 that is part of a pipeline. Measurements form each section of a pipe 78 may aid in determining the health of the pipeline.

FIG. 8 shows the sensor 70 directly attached to the pipe 78 and housed within the indent 74 of the attachment pad 72. The raised portion 76 is aligned with the indent 74 on the other side of the attachment pad. FIG. 8 also shows that the pipe 78 is hollow to allow fluids to flow through the lumen of the pipe 78. In some embodiments the pipe 78 may be comprised of plastic, or alternatively could be metal or another suitable material.

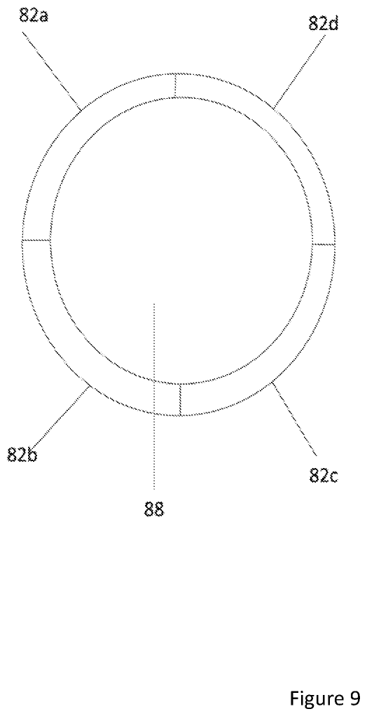

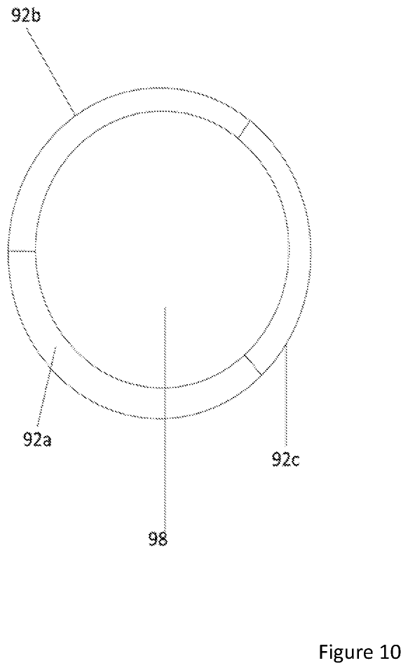

FIG. 9 shows four attachment pads 82 that together span the entire perimeter of the pipe 88. The attachment pads 82 span the entire perimeter once but only once. FIG. 10 also shows that the attachment pads 82 are tessellatable with themselves such that they span the perimeter. It is advantageous to span the perimeter of the pipe 88 such that the entire perimeter of the pipe 88 is protected, and so that any forces exerted on the pipe 88 do not disproportionately affect one area, and so increase strain on the pipe 88. Moreover, the tessellatable nature of the attachment pad 82 is preferable as it allows the entire surface to be covered by using more than one attachment pad 82a, 82b, 82c, 82d. If a single attachment pad 82 were needed to cover the entire surface of the pipe 88 this could represent a challenge in installation, whereas tessellating the pads together ensures that installation is comparatively easier.

It is noted that in other embodiments the pads 82 may not be fully tessellatable such that there may be gaps between the pads 82. This embodiment may not have the technical benefits associated with the tessellation described above, but for embodiments where coverage is not needed across a full pipe 88 circumference may still provide adequate protection for the sensors.

FIG. 10 shows three attachment pads 92 tessellated together to span the entire perimeter of the pipe 98. This is an alternative configuration to the one shown in FIG. 9 in which four attachment pads 82 were used. This may be advantageous for smaller pipes 98, or for configurations in which three sensors are used on the pipe 98. Any number of attachment pads 92 may be used to span the entire perimeter of the pipe.

It is noted that the sensors are not shown in FIGS. 9 and 10, and nor are the indents or raised portions of the attachment pad 92.

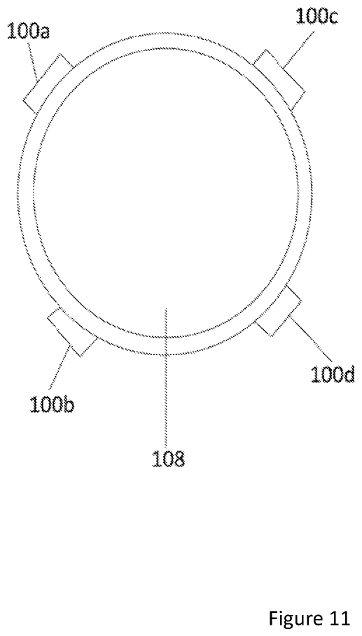

FIG. 11 shows four sensors 100a, 100b, 100c, 100d situated on a pipe 108. The Figure shows the arrangement in cross section. The attachment pads are not shown in FIG. 11. The top two sensors 100a, 100c in FIG. 11 are equidistant to the top of the pipe 108. The top of the pipe 108 is defined as the portion of the pipe 108 that is closest to the ground. In this case the top of the pipe 108 corresponds with the top of the pipe 108 as shown in the Figure. Indeed in FIG. 11 all four of the sensors 10a, 100b, 100c, 100d are equidistant each other, such that the axis between them forms an “X” shape across the cross-section of the pipe 108. The arrangement shown in FIG. 11 is advantageous as it allows the top of the pipe 108 to be accessed for essential maintenance without the need to remove a sensor 100 from its position on the pipe 108. Moreover, the sensors 100 being equidistant one another ensures that the sensors 100 measure the strain accurately, such that any strain events are captured. For example, it would be expected that should there be axial strain that having four sensors 100 equidistant one another the likelihood of detecting such an event is increased and indeed maximised.

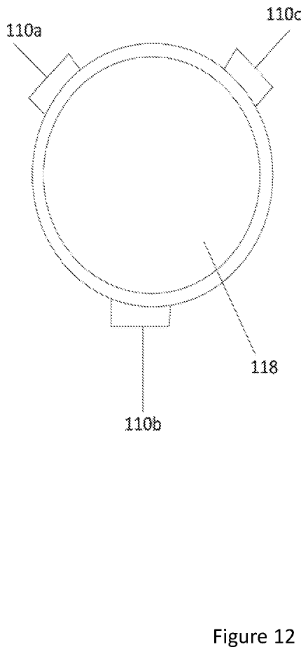

FIG. 12 shows an alternative arrangement in which three sensors 110a, 110b, 110c are situated on a pipe 118. Once more the three sensors 110 are positioned equidistant one another, and the sensors 110a, 110c nearest the top of the pipe 118 are equidistant the top of the pipe 118, and the top of the pipe 118 is kept clear for essential maintenance work. Any number of sensors 110 may be used to measure the strain of the pipe accurately. The arrangement shown in FIG. 12 is advantageous as it allows the top of the pipe to be accessed for essential maintenance without the need to remove a sensor from its position on the pipe 118. Moreover, the sensors 110 being equidistant one another ensures that the sensors 110 measure the strain accurately, such that any strain events are captured. For example, it would be expected that should there be axial strain that having three sensors equidistant one another the likelihood of detecting such an event is increased and indeed maximised.

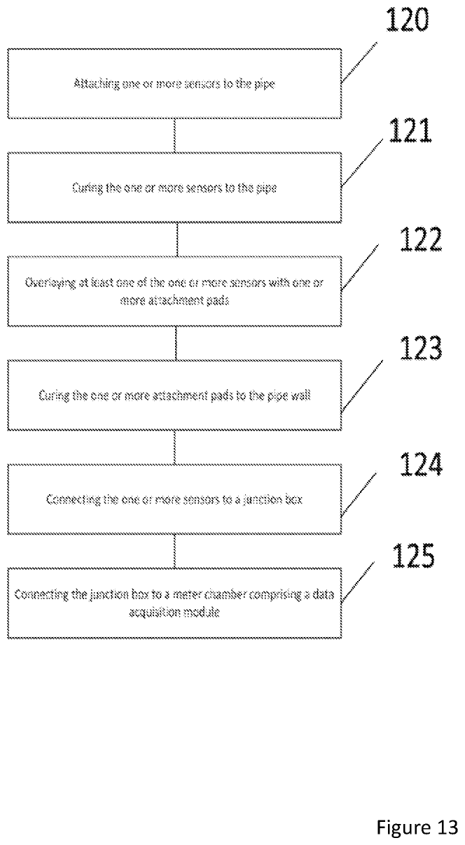

FIG. 13 shows a flowchart detailing steps that may be taken in the installation of the sensors on a pipe. It is noted that not all of the steps shown are essential to the method of installation, and FIG. 13 shows merely one embodiment of a method of installation that may be used.

Installation may be undertaken by attaching one or more sensors to a pipe, and overlaying one or more attachment pads over said sensors.

The first step 120 in FIG. 13 comprises attaching one or more sensors to the pipe. These sensors may be applied individually, or as a pack at the same time. This attachment may be achieved through the use of an adhesive, or by the use of friction of the sensor on the pipe alone. Alternatively mechanical ties or other mechanical links may be used to attach the sensors to the pipe.

The second step 121 is optional and comprises curing the one or more sensors to the pipe. The curing step may comprise exerting a force on the sensor to use pressure to cure the sensor to the pipe. Alternatively the sensor may be cured to the pipe through the application of temperature. In some embodiments both temperature and pressure may be used in the curing process.

The third step 122 of FIG. 13 comprises overlaying at least one or more of the sensors with one or more attachment pads. The attachment pad may completely overlie the sensor, or may partially overlie the sensor. The attachment pad may have an indent to house the sensor, and the sensor may be partially or fully housed within the indent. The attachment pad may have a raised portion in line with the indent. Overlying the sensor with the attachment pad protects the sensor from external forces and moisture.

The fourth step 123 is optional and comprises curing the one or more attachment pads to the pipe surface. The curing step may comprise exerting a force on the attachment pad to use pressure to cure the attachment pad to the pipe. Alternatively the attachment pad may be cured to the pipe through the application of temperature. In some embodiments both temperature and pressure may be used in the curing process. Alternatively the attachment may be achieved by electrofusion welding.

The fifth step 124 is optional and comprises connecting the one or more sensors to a junction box. A junction box is a connection hub that is configured to receive signals. Connecting the one or more sensors to the junction box enables the sensors to send measured data to the junction box. The junction box may be particularly advantageous if multiple sensors are used as it may serve as a connection point for receiving signals from all of the sensors, such that all of the data is collected at a single point. It is also noted that sensors may connect via a wireless protocol such as Bluetooth or Wi-Fi instead of through the use of a wired connection to a junction box. In yet another embodiment a junction box is not used and instead each of the sensors is directly connected with a meter chamber.

The final step 125 is similarly optional and comprises connecting the junction box to a meter chamber comprising a data acquisition module. The meter chamber may also comprise a power source such as a battery, or a mains connection in order to power the data acquisition module. The power may also feed the sensors, although in some iterations the sensors may have their own in-built power sources. The meter chamber may be designed to stop the ingress of moisture into the data acquisition module. The data acquisition module acquires data from the sensors. The data acquisition module may process the data locally to determine the health condition of the pipe, or alternatively may transmit the data elsewhere for further processing.

It is noted that each of the optional features may be removed from the method shown in FIG. 13. Therefore any combination of remaining features is envisaged as a method within the present disclosure.

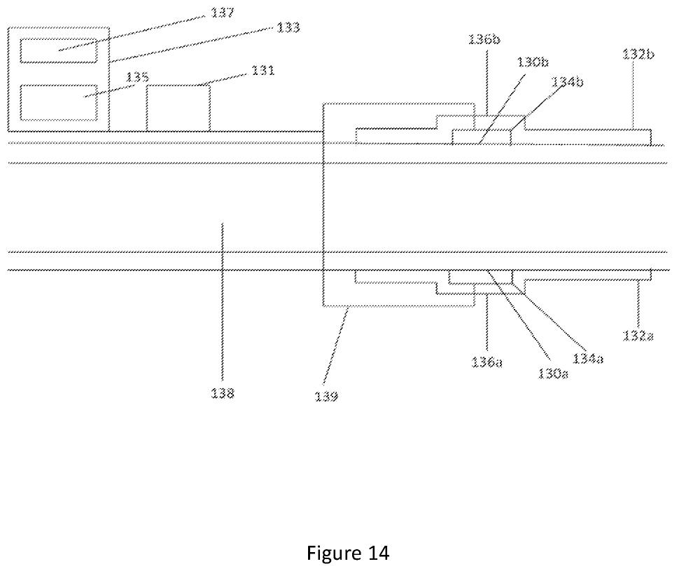

FIG. 14 is an illustration of the system for measuring a parameter of a pipe 138. FIG. 14 includes many optional features and is an illustration of one embodiment of such a system.

FIG. 14 shows a cross section of a pipe 138 with two sensors 130a, 130b mounted either side of the pipe 138. Attachment pads 132a, 132b overlie the sensors 130a, 130b, such that the indent 134a, 134b of the attachment pads 132 houses the sensors 130. The attachment pads 132 have a raised section 136a, 136b in line with the indent 134. The thickness of the attachment pad 132 is substantially uniform. The outputs 139 of the sensors are fed through the attachment pads 132 and join together and are connected to a junction box 131. The junction box 131 is in turn connected to a meter chamber 133. The meter chamber 133 houses a data acquisition module 135 and a power source 137.

The attachment pad 132 may be connected to the pipe 138 by adhesive. Alternatively the attachment pad 132 may be cured to the pipe 138 without the use adhesive. Alternatively there may be sufficient friction between the attachment pad 132 and the pipe 138 to keep the attachment pad in situ. Similarly the sensor 130 may be attached with adhesive, through curing, or by the use of friction.

The data acquisition module 135 is configured to be in communication with at least one sensor 130 to receive data, the data acquisition module 135 configured to process the data to determine one or more properties of the pipe 138. This may be as shown in FIG. 14 via the junction box 131, or a direct connection between the data acquisition module 135 and the sensors 130 may be made. The data acquisition module 135 may determine the one or more properties of the pipe 138, or may send this data to an external device for further processing.

The meter chamber 133 is configured to be weatherproof, such that data acquisition module 135 is not affected by ground water. The power source 137 may be mains or a local source such as a battery.

Although not shown in FIG. 14 the system may further comprise a pressure sensor. The pressure sensor may be tapped into the pipe 138 in the method of installation, or may be installed separately. Preferably the pressure sensor is located adjacent to one or more sensors 130 such that the pressure may be pressured at a point at which a further property of the pipe 138, such as strain is measured. These values may be used to determine the health condition of the pipe 138. The pressure sensor may measure the pressure of fluid within the pipe 138, or pressure on the surface of the pipe 138, or within the wall of the pipe 138 itself. The tapping may be achieved by first boring a hole into the pipe 138, or by tapping the sensor itself into the pipe 138. The pressure sensor may be located at the top of the pipe 138 (nearest the surface of the ground) so that it may be removed and the tap used for routine maintenance.

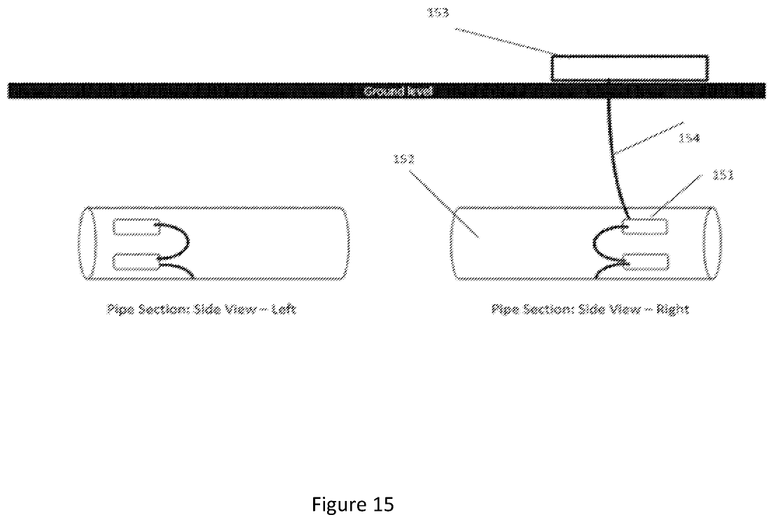

FIG. 15 shows an embodiment of the system in which no junction box is present and the plurality of sensors are arranged in series with one another, and are connected directly to the data acquisition module 153 which is positioned above the ground. FIG. 15 shows a plurality of attachment pads 151 attached to a pipe 152, and beneath each attachment pad is at least one sensor. The use of a junction box may have drawbacks as the junction box may be susceptible to the pressure from the earth (and movement in the earth may exert significant forces on the junction box), or from water ingress. In order to remove the junction box from the system in this embodiment the sensors are connected to the data acquisition module directly. In this embodiment there is a single connection 154 between the sensors and the data acquisition module 153. The sensors are therefore connected in series so that only one connection to the data acquisition module is needed. This also provides less points of failure, however if this one connection 154 were to fail then all data transmission from the sensors to the data acquisition module 153 will cease. The connection between the sensors and the data acquisition module may be any suitable connection.

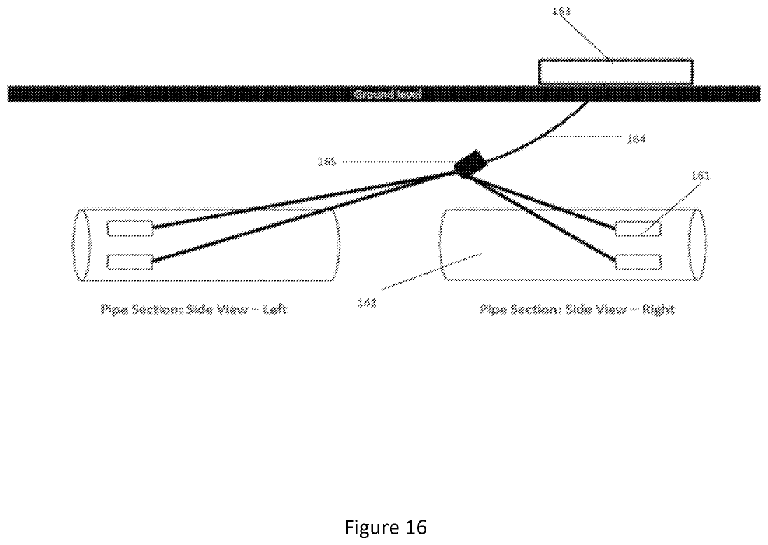

FIG. 16 shows an embodiment of the system in which no junction box is present and the plurality of sensors are arranged in parallel with one another and are connected to the data acquisition module 163 via a connecting element 165. FIG. 16 shows the sensors beneath the attachment pads 161 as described above in relation to FIG. 15. Each sensor is independently connected to the connecting element 165, and then the connecting element has a single connection 164 to the data acquisition module 163. As an alternative some of the connections to the connecting element may be in parallel and some may be in series. Moreover, the connective element may simply position the connections such that they are adjacent one another, but so that each connection still conducts separate signals to the data acquisition module. In the event one connection fails the remainder will still function, and so this is an advantage over the series system described above. However, this system may cost more to implement.

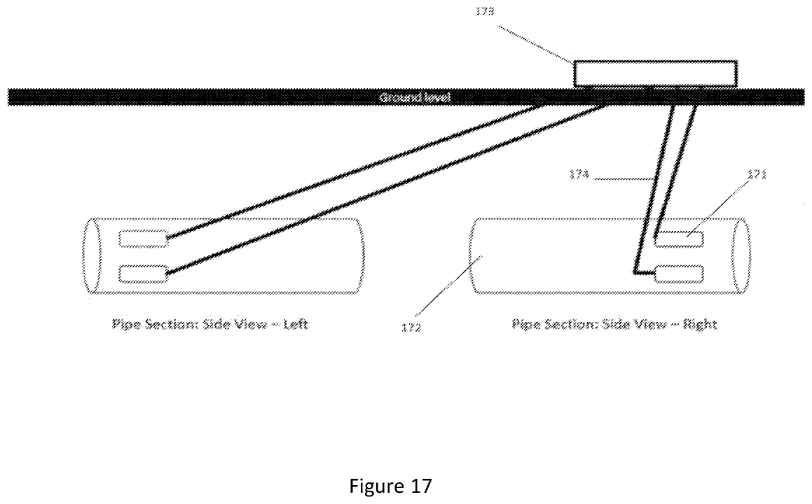

FIG. 17 shows an embodiment of the system in which no junction box is present and the plurality of sensors are arranged in parallel with one another, and are connected directly to the data acquisition module 173. The sensors are beneath the attachment pads 171 in FIG. 17. There is no connecting element present in this embodiment. This has the advantage that if one connection fails the remaining connections still transmit data. However this increases the complexity of the system.

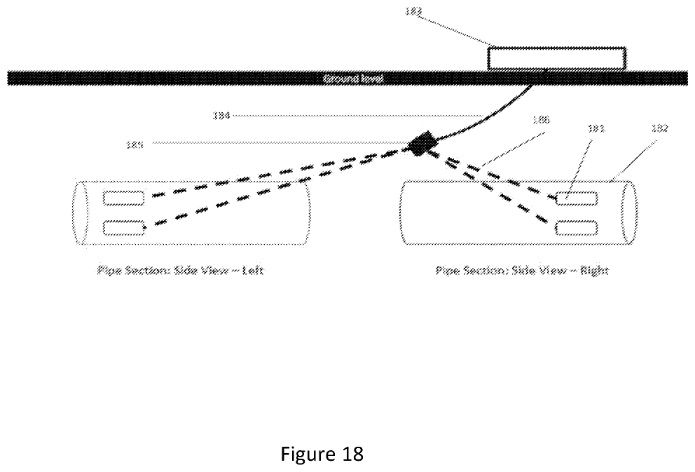

FIG. 18 shows an embodiment of the system in which the junction box 185 is present and the plurality of sensors are arranged in parallel with one another. Two types of connections are shown. The first 186 are shown as dashed lines and connect the sensors to the junction box. The second 184 shown in solid line connect the junction box to the data acquisition module 183.

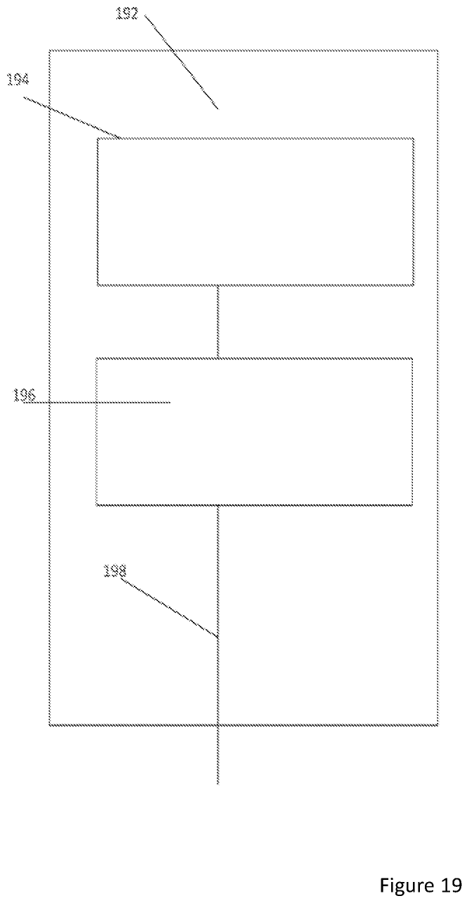

FIG. 19 shows an embodiment in which an analogue to digital converter 196 is positioned adjacent the attachment pad 192 and the sensor 194. This means that if the sensor 194 is configured to record or send analogue data then the analogue data has to travel only a short distance (of the order of a few centimetres) to reach the analogue to digital converter 196.

Analogue signals are often harder to reconstruct than digital signals once they have been distorted. In the present use case signals may be distorted by vibrations in the earth for example, and therefore some distortion may occur between the sensor and the data acquisition module. Positioning the digital to analogue converter 196 adjacent the sensor 194 and the attachment pad 192 may therefore increase the quality and/or usefulness of the signals that are received by the data acquisition module.

The analogue to digital converter 196 may be directly coupled with the sensor 194. They two elements may be manufactured together. The attachment pad 192 may contain a second recess for the analogue to digital converter, or alternatively the first recess may be large enough to encompass both the sensor and the analogue to digital converter. The recess or recesses may be potted with silicone to reduce forces transmitted to the analogue to digital converter or the sensor. The attachment pad may be moulded directly over the sensor, and optionally over the digital to analogue converter 196 during manufacture. The analogue to digital converter 196 may for example be miniaturised and may be situated on a multilayer PCBA or a flexible substrate.

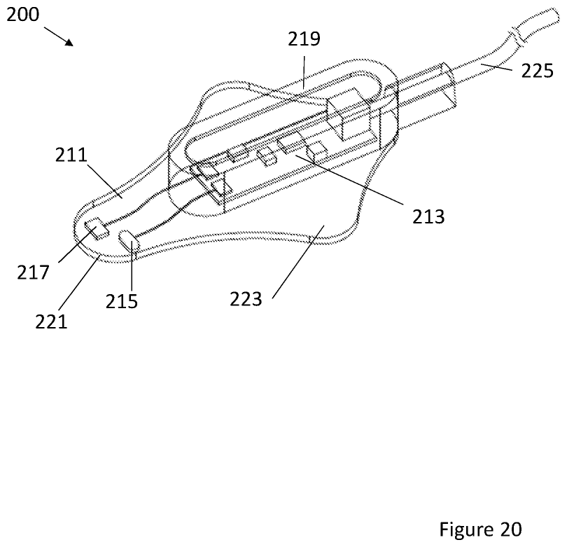

FIG. 20 shows a sensor for measuring parameters of a pipe, the sensor comprising: a sensor body comprising a pipe engaging surface; a first measurement device positioned within the sensor body and configured to contact the surface of the pipe when the pipe engaging surface is in contact with the surface of the pipe, wherein the first measurement device is configured to measure a first parameter of the pipe; a data conduit configured to pass the measurement from the measurement device to an external unit.

In particular, FIG. 20 shows a second embodiment of a sensor 200 that may be used for conducting various investigations on various types of pipes, in particular water pipes. That being said, it may be that the sensor of FIG. 20 provides particular uses for investigations conducted on subterranean pipes.

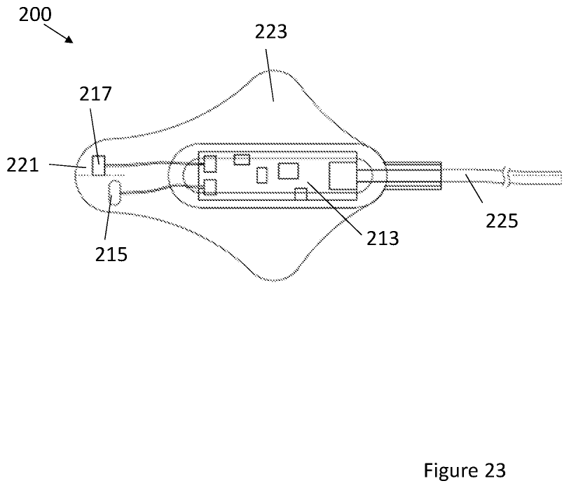

The sensor 200 seen in FIGS. 20-23 comprises a rubberised body 211 used for housing various processing, controlling 213 and measuring instruments 215, 217. These instruments and the sensor body 211 together form a compact friction fitted unit 200 that can be placed onto a pipe surface (not shown). The sensor body 211 itself has an elongated central portion 219, a longitudinally extending first flange 221 and a pair of laterally extending secondary flanges 223. Each of these flanges can be seen to extend from the central portion outwards and taper down in width as they do so.

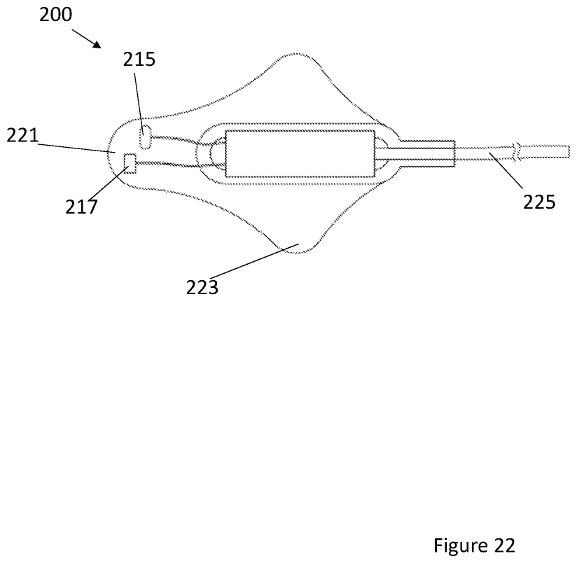

The underside surfaces of these flanges 221, 223, best seen in FIG. 22, are the primary pipe engaging portions of the sensor body. These surfaces are sized and shaped such that they provide a large surface area for an adhesive (not shown) to be applied to and ensure a strong attachment with the pipe surface (not shown). However, it may be that an adequate attachment of the sensor 200 onto the pipe is still achieved without an adhesive courtesy of the rubberised construction of the sensor body 211 providing a frictional attachment with the pipe surface. The flanges 221, 223 may aid such attachment by providing a large area upon which the friction may act and restrict motion in both the longitudinal and transverse direction as a result of their extension in both these directions.

In the embodiment seen in FIGS. 20-23, two measuring instruments 215, 217 are accommodated within the first longitudinally extending flange 221 of the sensor body 211 and a controller 213 is accommodated within the central portion 219. A particular advantage of accommodating the measurement instruments 215, 217 within the first flange 221 may be that this location provides a user with a useful reference point as to the exact location of the instruments when placing the sensor 200 at precise locations on the pipe surface. This may be especially useful since the sensor body 211 may not be transparent from a top view and a user's view may therefore be obstructed. Alternatively, the two measurement instruments 215, 217 may be accommodated within any other portion of the sensor body 211, be it the central portion 219 or the lateral flanges 221, 223 (arrangement not shown).

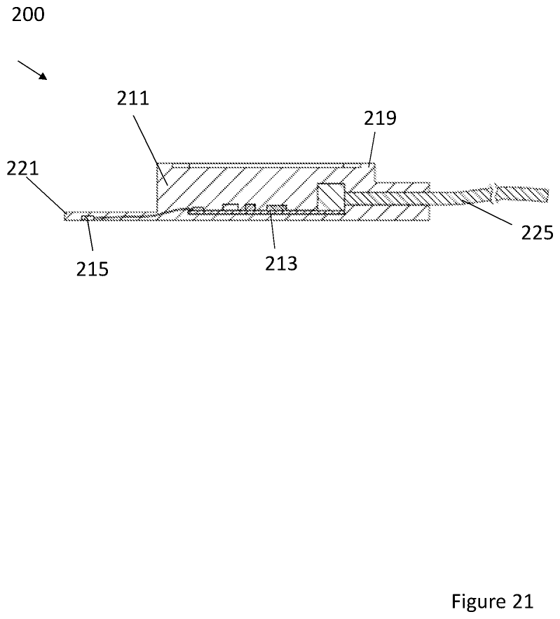

The two measuring instruments 215, 217 that are held within the sensor body 211 in FIGS. 20-23 are held such that their depths reside entirely within the depth of the sensor body 211, best seen in FIG. 21, and yet they have a portion of their architecture exposed and uncovered by the sensor body. In this embodiment, the controller 213 is completely encapsulated within the sensor body 211 in the central portion 219. The exposed portion of the instruments 215, 217 is the portion that is to directly abut a pipe surface (not shown) when the sensor 200 is placed atop (or onto) a pipe. This would therefore be the portion of the instruments 215, 217 that is to carry out the measurements of the pipe parameters. This exposed face lies flush in line with the pipe engaging faces of a sensor body (the underside of the flanges 221, 223) such that both the instruments 215, 217 and the sensor body 211 may contact a pipe surface when placed atop it. The measuring instruments 215, 217 do not protrude beyond the underside of the sensor body 211.

The above described flush arrangement enables the sensor body 211 to, firstly, form a seal with the pipe around the delicate instruments 215, 217, and secondly, allows the instruments access to directly contact the pipe surface. This seal prevents fluid ingress into the instruments which may otherwise lead to damage of the instruments or inaccuracy in their performance. The direct access to the pipe enables the instruments to perform their duties with maximal accuracy. The seal that is achieved with such arrangement may also achieve a substantially strong connection between the pipe and sensor which may minimise the chance of an external shock changing the position of the sensor 200 relative to the pipe.

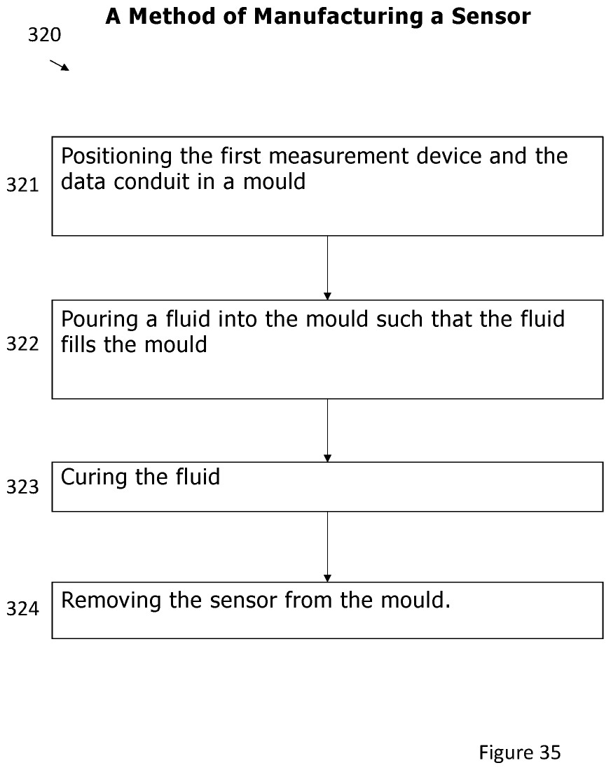

To achieve the above flush fit, the sensor body 211 may be formed by method of casting around the instruments 215, 217 and controller 213 (and data conduit 225) to be held. This will be explored in FIG. 35 further. Such practice ensures the casted material is moulded to the exact shape of the instruments and thus reduces the tolerance available for fluid to enter the system. As a result, the sensor body 211 may be formed from a polymeric material, such as silicone or polyurethane. Alternatively, in some embodiments the sensor body 211 may not be rubberised yet achieve a tight tolerance with the measurement instruments through other means. This tight tolerance may also aid in stabilising the positions of the instruments 215, 217 with respect to both the sensor 200 and pipe (not shown) which may aid in improving accuracy.

The two measuring devices 215, 217 seen in FIGS. 20-23 are held in close proximity to one another. This proximity may enable investigations into the relationship between the two separate pipe parameters each instrument measures. The two instruments seen in FIGS. 20-23 may be a strain measuring instrument 215 and a thermometer 217. The parameters of pipe temperature and pipe local strain may be linked, and so an investigation into the relationship between these two parameters may allow changes in strain in the pipe to be understood more deeply. And where changes are not as a result of temperature, can then be identified as strain events. The data from these instruments 215, 217 may be processed within the controller 213 held in the central portion of the sensor, whereby the controller may be able to modify the strain measurements to take into account temperature fluctuations that have been detected. This may allow the health of the pipe to be assessed. Other embodiments may explore the relationship between other pipe parameters and utilise other measuring instruments held in the same proximity.

Alternatively, it may be entirely possible and of use to include only one of a particular instrument, i.e. either a strain sensor 215 or thermometer 217. Equally, it may be possible to utilise a plurality of further instruments alongside the strain sensor 215 and thermometer 217. Additional instruments (not shown) that may be accommodated within either the flanges 221, 223 or the central portion of the sensor body 211 include, an accelerometer for detecting any acceleration or motion of the sensor, a load cell and a moisture detection unit. Each of these instruments may provide data that is of use in and of themselves. A moisture detection unit may be located outside of the sensor, and may be situated within or adjacent soil or earth adjacent the sensor or pipe. The moisture detection unit may be part of the same system, or connected to the pipe.

An accelerometer may aid in detecting events that cause breakages or damage to the pipe. These may include recording seismic activity and more particularly, monitoring the seismic activity such that it is alerted to a user should it rise above a predefined threshold. A load cell may monitor the load experienced by a particular location on a pipe such that a concentrated load area may be identified. This may also detect the load for example from vehicles and the like. This may show areas of high stress, due to heavy loads, or vehicles travelling at high speeds. Such loads may damage the pipe or reduce its lifespan, so monitoring of these loads may allow better planning of maintenance. And a moisture detecting unit may aid in determining the moisture levels atop or adjacent a pipe, and monitoring these levels such that they are kept at below a predefined threshold. When moisture levels drop below a certain threshold the damping effect of the earth on the pipe is reduced and so pipes are more prone to damage. Monitoring this may allow the usage of pipes to be changed when such low moisture events are detected in order to reduce the risk of pipe breakage. These may aid in identifying prone areas of pipes that may need further maintenance attention.

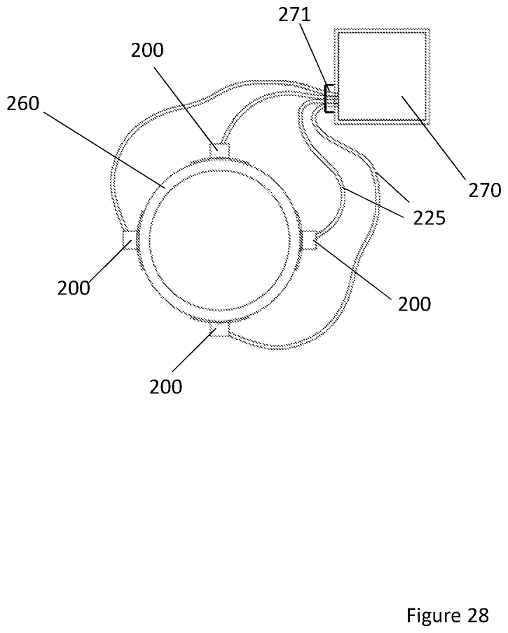

It is of note that the accommodation of larger hardware, such as a controller 213 or accelerometer may be best suited for the central portion 219 as to being embedded within the flanges 221, 223. This is because there may be greater depth to the sensor body 211, and therefore available space, in the central portion 219. Equally, more fragile instruments 215, 217 may be kept in the central portion 219 as it may provide a greater thickness of rubberized material encapsulating it for added protection as compared to the flanges 221, 223. Alternatively, it may be entirely possible to accommodate controllers 213, and larger or more fragile architecture in an entirely separate location adjacent to the sensor 10 in a place such as a junction box (not shown). This will be explored in FIGS. 28 to 31.

The sensor of FIGS. 20-23 is also equipped with a data conduit 225. The data conduit 225 is a wired connection that partly resides within the sensor body 211 and extends from the opposite side to the first flange 221. It is used to transfer the measured data to an external means or unit for further processing or storage. This external means or unit may be some distance away from the sensor and in the context of subterranean pipes, may be positioned above ground level. Optionally this may be replaced with a wireless connection in some embodiments.

Alternatively, prior to sending data to an external box, the data may be sent to a junction box (not shown) located adjacent the pipe and sensor 200 and below ground level. Such an arrangement may be useful in that it may allow data from a plurality of sensors 200 at different locations on a pipe (or on different locations on different pipes) to be processed centrally and packaged in a form that may enable more favourable transport of the data over a longer distance. This may improve the overall efficiency of the system.

One practice of data processing that may aid such efficiency and improve system accuracy may be to convert analogue signals as measured by any of the measuring instruments to digital signals prior to transmitting them to the external unit. This would allow the analogue data recorded from measurement devices to be converted into a digital form that is less susceptible to transit noise or interference. This operation may be conducted in a controller 213 within the sensor of FIGS. 20-23, or it may be conducted in a junction box (not shown) that is located in the vicinity of the sensor and pipe. The benefits of conducting it in the junction box may include that a larger and more efficient analogue to digital converter may be used or that the junction box may receive (and convert) multiple signals from different sensors concurrently. This may be more efficient. Nevertheless, such operations may take place via a controller 213 held within the sensor 200. In this case the distance any analogue signal must be sent is negligible which will further reduce noise induced into the signal.

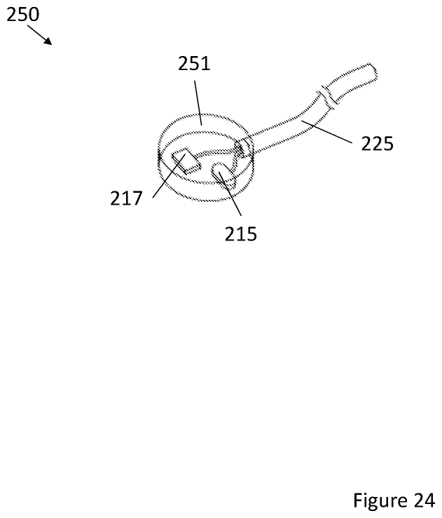

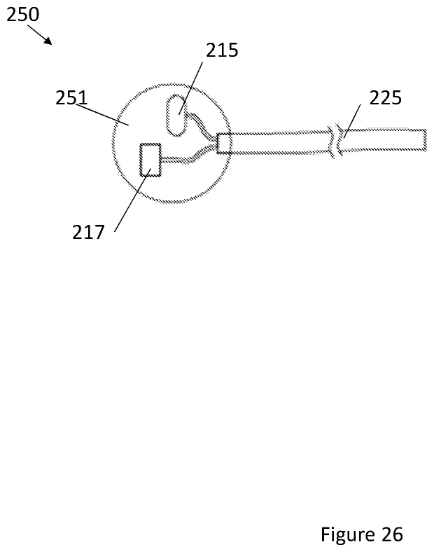

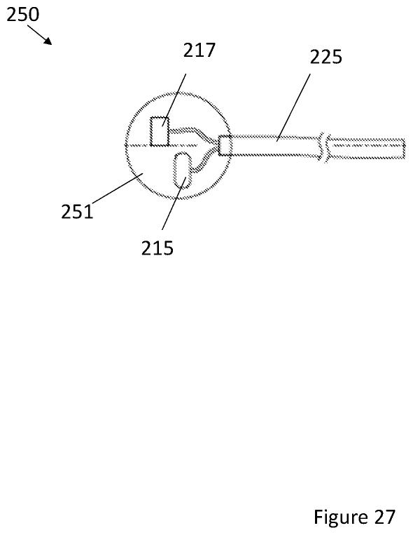

FIGS. 24-27 show a third embodiment of a sensor 250. The sensor body 251 seen in FIGS. 24-27 is a cylinder with a cross sectional diameter larger than its depth. The depth of this cylinder may be 1 cm, or even less than 1 cm in some embodiments. The resultant shape of the cylinder body may therefore more closely resemble a puck or disc. Such embodiment of the sensor may be simple to manufacture and time efficient to fit onto a pipe. Due to the lack of available space for a sufficiently sized central portion, this sensor embodiment may have a preference not to accommodate a controller (or any other sizeable component). This may make the sensor of this embodiment particularly simple to manufacture and fit to the pipe. Therefore, it may be particularly advantageous to use the sensor of FIGS. 24-27 alongside a junction box (not shown), whereby the junction box may house the controller and other larger architecture.

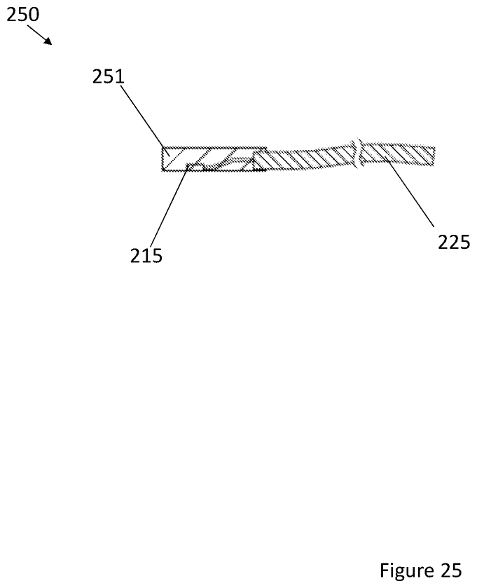

With such embodiment of sensor 250, it may be that only smaller sensory instruments 215, 217 are accommodated within the sensor as shown with a wired conduit 225 connecting the sensor 250 to a junction box that may house the controller. Once again, the sensors 215, 217 accommodated within the sensor form a flush connection with a pipe along with the underside of the cylindrical sensor as best seen in FIG. 25.

Due to the more compact shape of the sensor embodiment of FIGS. 24-27, it may be easier to place the sensory 215, 217 instruments at a desired location on a pipe. This may be for accessibility reasons or since the compact and smaller disc sensor provides a user with a more localised reference point.

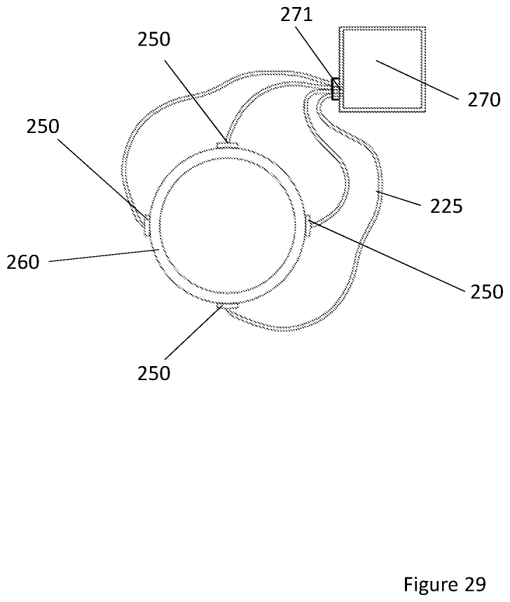

FIGS. 28 and 29 show cross sectional views through a pipe 260 to which a plurality of sensors are attached. FIG. 28 shows sensors 200 of the second embodiment whilst FIG. 29 shows sensors 250 of the third embodiment. An arrangement of a plurality of sensors may allow for the concurrent investigations on a plurality of pipe locations. This may aid in investigating the relationship between parameters at different locations or provide sufficient data to characterise the health of a pipe more reliably. It may also be more time efficient to conduct a number of investigations simultaneously.

For example, each sensor upon the pipe may accommodate one of a load cell, accelerometer, moister gauge, strain gauge or thermometer as their main measuring instrument and the system of the plurality of sensors shown in FIG. 28 (and FIG. 29) may lead to a comprehensive study of the pipe in great detail. Again, a moisture detection unit (not shown) may be placed within/adjacent the earth in the vicinity of the sensor/pipe, rather than within the sensor itself in some embodiments. It may form part of the same system, or may be connected to the sensor, or to the same junction box as the sensor. The sensor equipped with the load cell encapsulated in the sensor body may allow the load on the pipe to be determined and monitored live during use of the pipe. A moisture gauge, equipped with two prongs and a capacitive moisture sensor, may be configured to detect the moisture level of the surrounding earth or soil. This may advantageously allow any dry conditions resulting in an undamped pipe to be identified. The sensor and thermometer sensors may work in tandem as discussed previously or independently.

FIGS. 28 and 29 also show a junction box 270 that each sensor connects to via a data conduit 225. The connection between the data conduit of each sensor and the junction box may be a male-female connection that is water tight, or water repellent, so as to prevent the ingress of water into either element. This may reduce noise on the signal, and increase the lifespan of the system. The data conduit 225 as seen in the embodiments of FIGS. 28 and 29 may be encapsulated partly within the junction box 270, 271. The conduit 225 and box may therefore be taken to be a single entity to be fitted together onto a pipe with a sensor to be placed, or formed, around the opposite end of the data conduit 225 resulting in a conduit that resides partially within a sensor and partly within the junction box 270. This arrangement may reduce the time associated with installation and may also reduce any chance of water ingress.

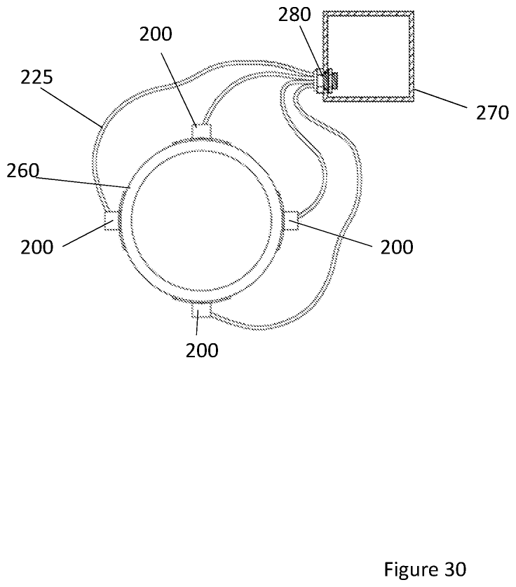

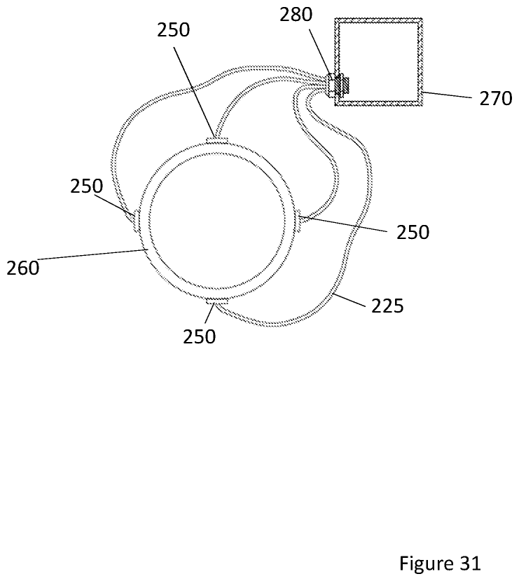

Alternatively, the data conduit may be connected to the junction box via a stuffing gland 280 as seen in FIGS. 30 and 31. The stuffing gland 280 may be made of a hard plastic or metal and therefore provide additional support to the ends of each conduit 225 where they fit into the junction box 270. This may ensure they are kept firmly in place. There may be one stuffing gland per data conduit 225—as opposed to the single stuffing gland for the plurality of data conduits 225 as shown. Moreover, for some embodiments a female to female connection may be used and therefore two stuffing glands may be used per connection, connected in series to one another.

The benefits of utilising the arrangement of a plurality of sensors (200 or 250) feeding into a singular junction box 270, as seen in FIGS. 28-31, has been mentioned previously in terms of time efficient processing and effective packaging of the data prior to transit. However, such an arrangement may also reduce the overall power required by the system as a singular controller may be used within the one junction box that conducts the processing of the data from the plurality of sensors seen in these Figures. This may be especially useful for some operations that may consume high amounts of power or for use in a subterranean environment that may rely on battery power that may need to be conserved.

For operations such as data conversion from an analogue signal to a digital one prior to transit, such an arrangement may be ideal as many different analogous signals from the plurality of sensors may be processed concurrently, in a power and time efficient manner. This may be especially useful for a moisture gauge that measures data in analogue form.

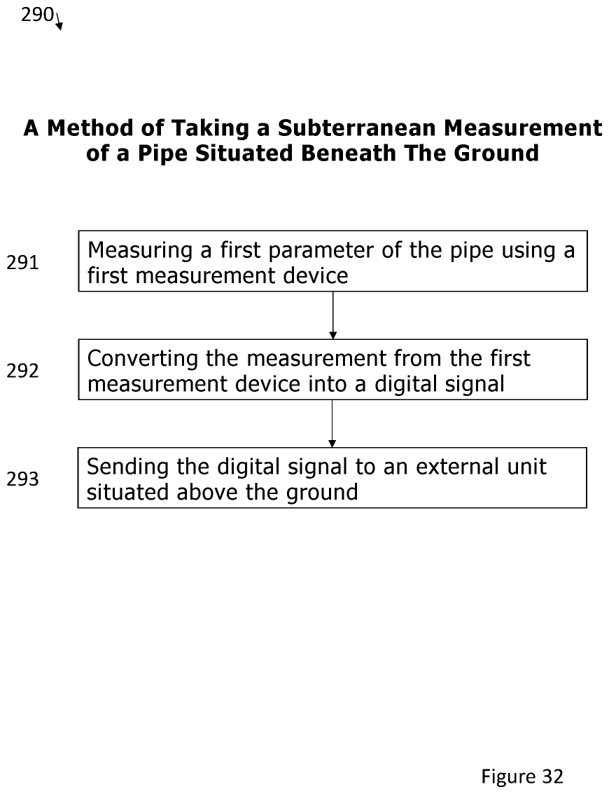

FIG. 32 shows a flowchart outlining a first method of taking a subterranean measurement of a pipe situated beneath the ground and converting it into digital form 290. The method may commence by measuring a first parameter of the pipe using a first measurement device 291, and then converting this measurement into a digital signal 292. This may be conducted via an analogue to digital converter built into a controller. Additionally, conducting this step in the proximity of the sensor and prior to transmitting it above ground may allow for a more accurate, less noise interfered signal. The final step of the method 293 may be to send the digital signal to an external unit situated above the ground for further processing and analysis.

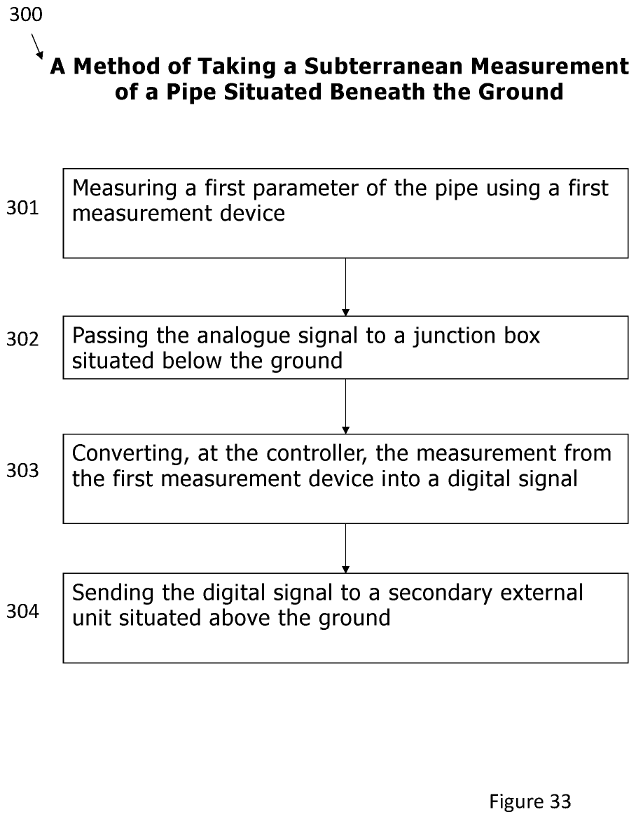

FIG. 33 shows a flowchart outlining a second method 300 of taking a subterranean measurement of a pipe situated beneath the ground. This method is largely similar to the method of FIG. 32 and similarly may commence with measuring a first parameter of the pipe using a first measurement device 301. This analogue signal may then be passed to a junction box situated below the ground 302, wherein the external unit may comprise a controller. The controller may then convert this analogue measurement from the first measurement device to a digital signal 303 which may then be sent to an external unit situated above the ground 304. This may provide an alternative embodiment in which noise is reduced, and power used by the system is also reduced.

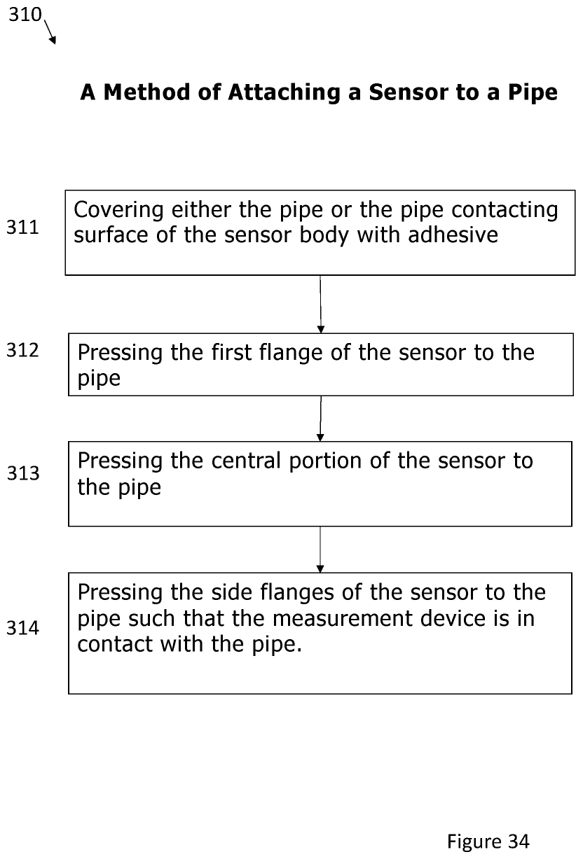

FIG. 34 shows a flowchart outlining a method 310 of attaching a sensor to a pipe. The initial step may be to cover the portion of the pipe that the sensor is to be attached onto or the pipe contacting surface of the sensor with an adhesive 311. Then, pressing the longitudinal first flange of the sensor in place 312, followed by the central portion 313 and then the side flanges 314 such that the sensor is attached linearly first and then laterally constraint. This method may allow for some margin of adjustment when attaching the sensor onto the pipe as leaving the attachment of the side flanges till last may allow for some freedom of movement. Additionally, the first flange may comprise the measurement instruments which may be positioned onto a pipe more precisely should they be placed first and without constraint from other portions of the sensor.

FIG. 35 shows a flowchart outlining a method 320 of manufacturing a sensor. The method may begin by positioning the first measurement device and the data conduit in a mould 321 following by pouring a fluid into the mould such that the fluid fills the mould 322. This step may also comprise placing a controller in the mould, and preferably in the central portion of the mould. The control may be either completely encapsulated within the mould (which may require it being raised within the mould when forming) or it may be flush with the underside of the sensor body. After this fluid has cured 323, the sensor and conduit (and optionally controller) may be removed from the mould 324.

The invention extends to methods, system and apparatus substantially as herein described and/or as illustrated with reference to the accompanying figures.

The invention also provides a computer program or a computer program product for carrying out any of the methods, processes or determinations described herein, and/or for embodying any of the apparatus features described herein, and a computer readable medium having stored thereon a program for carrying out any of the methods, processes or determinations described herein and/or for embodying any of the apparatus features described herein.

The invention also provides a signal embodying a computer program or a computer program product for carrying out any of the methods described herein, and/or for embodying any of the apparatus features described herein, a method of transmitting such a signal, and a computer product having an operating system which supports a computer program for carrying out the methods described herein and/or for embodying any of the apparatus features described herein.

Any feature in one aspect of the invention may be applied to other aspects of the invention, in any appropriate combination. In particular, method aspects may be applied to apparatus aspects, and vice versa. As used herein, means plus function features may be expressed alternatively in terms of their corresponding structure, such as a suitably programmed processor and associated memory.

Furthermore, features implemented in hardware may generally be implemented in software, and vice versa. Any reference to software and hardware features herein should be construed accordingly.

It should be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

What is claimed:

1. A sensor for measuring parameters of a pipe, the sensor comprising:
a sensor body having a pipe engaging surface;
a first measurement device configured to contact a surface of the pipe when the pipe engaging surface is in contact with the surface of the pipe, the first measurement device being configured to measure a first parameter of the pipe; and
a data conduit configured to pass a measurement of the first parameter from the measurement device to an external unit.

2. The sensor of claim 1, wherein the first measurement device is configured to output an analogue measurement that is converted to a digital signal in a vicinity of the pipe.

3. The sensor of claim 1, wherein the sensor body is comprised of at least one of a casted material that is set around the first measurement device and the data conduit.

4. The sensor of claim 1, wherein the first measurement device is configured to lie flush with the pipe engaging surface of the sensor body.

5. The sensor of claim 1, further comprising a second measurement device configured to contact the surface of the pipe when the pipe engaging surface is in contact with the surface of the pipe, wherein the second measurement device is configured to measure a second parameter of the pipe.

6. The sensor of claim 5, wherein:
the first measurement device is configured to measure strain; and
the second measurement device is configured to measure temperature.

7. The sensor of claim 1, further comprising an accelerometer configured to detect any acceleration or motion of the sensor, wherein a notification is created if an acceleration over a first threshold is detected, the first threshold being indicative of at least one of an external subterranean stimulus.

8. The sensor of claim 1, further comprising an additional sensor that is encapsulated within the sensor body.

9. The sensor of claim 1, wherein the pipe is positioned underground, and wherein the sensor is configured to be positioned on the pipe underground.

10. The sensor of claim 1, wherein the sensor body is cylindrically shaped, wherein a diameter of a cross sectional area is larger than a depth of the cylindrical shape, such that the sensor body is approximately disc or puck shaped.

11. The sensor of claim 1, wherein the sensor further comprises a controller encapsulated within the sensor body that is configured to convert measurements from the first measurement device into a digital signal.

12. The sensor of claim 1, wherein:
the pipe engaging surface further comprises a first flange extending from a central portion that extends longitudinally in a first direction and is dimensioned such that a longest side of the central portion extends in the first direction,
the first flange extends further in the first direction,
wherein the first measurement device is housed in the first flange, and
the second measurement device is housed in the first flange.

13. The sensor of claim 12, wherein the pipe engaging surface comprises two side flanges extending from the central portion, with the first direction being perpendicular to the two side flanges.

14. The sensor of claim 13, wherein the data conduit comprises a wired connection that is positioned to extend away from the central portion in the opposite direction to the first flange.

15. A system comprising:
a junction box;
at least one sensor of claim 1;
wherein the at least one sensor is attached to the junction box via the data conduit.

16. The system of claim 15, further comprising an analogue to digital converter for converting the measurement from the first measurement device to an analogue signal.

17. The system of claim 15, wherein the at least one sensor is a plurality of sensors.

18. The system of claim 15, wherein the attachment between the junction box and the data conduit is configured to be water resistant.

19. The system of claim 15, wherein:
at least one sensor comprises a load cell encapsulated in the sensor body and that is configured to be positioned atop the pipe.

20. A method of taking a subterranean measurement of a pipe situated beneath the ground comprising:
measuring a first parameter of the pipe using a first measurement device;
converting the measurement from the first measurement device into a digital signal, wherein said conversion takes place locally under the ground; and
transmitting the digital signal to an external unit situated above the ground.
